(19) United States
(12) Patent Application Publication
(10) Pub. No.: US 2025/0181616 A1
(43) Pub. Date: Jun. 5, 2025

(54) PROMPT TUNING METHOD, PROMPT TUNING APPARATUS, AND NON-TRANSITORY COMPUTER-READABLE RECORDING MEDIUM

(71) Applicants: Hongyu LI, Beijing (CN); Bin Dong, Beijing (CN); Shanshan Jiang, Beijing (CN); Yuming Zhang, Beijing (CN); Yongwei Zhang, Beijing (CN)

(72) Inventors: Hongyu LI, Beijing (CN); Bin Dong, Beijing (CN); Shanshan Jiang, Beijing (CN); Yuming Zhang, Beijing (CN); Yongwei Zhang, Beijing (CN)

(73) Assignee: Ricoh Company, Ltd., Tokyo (JP)

(21) Appl. No.: 18/958,401

(22) Filed: Nov. 25, 2024

(30) Foreign Application Priority Data
Nov. 30, 2023 (CN) 202311641388.9

(51) Int. Cl. G06F 16/3329; G06F 16/3349

(52) U.S. Cl. CPC G06F 16/33295; G06F 16/3349

(57) ABSTRACT

A prompt tuning method, a prompt tuning apparatus, and a non-transitory computer-readable recording medium are provided. In the method, an original prompt input by a user is received. Then, a first model is guided to start a question answering process based on the original prompt, and the first model is requested to answer the original prompt according to the original prompt and context information obtained in the question answering process. The question answering process includes at least one of a process where the first model asks a question and the second model answers the question, and a process where the first model asks a question and answers the question. Then, the answer to the original prompt generated by the first model is obtained.

### CROSS-REFERENCE TO RELATED APPLICATIONS

The present disclosure claims priority under 35 U.S.C. § 119 to Chinese Application No. 202311641388.9 filed on Nov. 30, 2023, the entire contents of which are incorporated herein by reference.

### BACKGROUND OF THE INVENTION

### 1. Field of the Invention

The present disclosure relates to the field of machine learning and natural language processing (NLP), and specifically, a prompt tuning method, a prompt tuning apparatus, and a non-transitory computer-readable recording medium.

### 2. Description of the Related Art

In recent years, large language models (hereinafter referred to as large models) represented by ChatGPT, ChatGLM and the like have become the focus of attention in the field of artificial intelligence due to their excellent generation capabilities and broad application prospects. The large models have shown amazing potential in many fields such as natural language processing, dialogue systems, and text creation, and have promoted the development of intelligent interaction technology. However, in practical applications, the “prompt” serving as the input of the large model greatly affects the quality of the model generation results. How to accurately guide the large model to generate a text with a specific type or content has become an important challenge.

“Prompt tuning” aims to optimize the prompts input by a user and guide the large model to more accurately generate output that meets the needs of the user. At present, some companies hire professional prompt engineers to perform prompt tuning for different tasks, while other companies or service providers provide automated prompt tuning services. Users can complete the tuning of any prompt by entering the prompt on website provided by the companies or calling an application programming interface (API). In addition, if the automated prompt tuning can be integrated into a pre-processing module of the large model service, the accuracy of response of the large models to user prompts can be greatly improved, and the probability of users inputting multiple times due to dissatisfaction with the generated results can be reduced, thereby greatly improving the user experience.

In a prompt tuning method of the conventional technology, for the target task specified by the user, a user enters pairs of input/output for the task into a fixed template, and the large model generates candidate prompts according to the input/output pairs. For each generated candidate prompt, the candidate prompt and its input/output pair for evaluation are input into the large model to obtain a generated result, and the candidate prompt is evaluated by scoring the generated result. Then, the candidate prompt with the highest score in the evaluation is selected as the optimal prompt for the target task. The above method uses the input/output pair data of the target task to generate/evaluate the candidate prompts, which will occupy a lot of computing resources and consume a lot of time. In addition, the number of target tasks specified by individual users is huge, the differences between tasks are also large, and it is difficult for individual users to provide input/output pair data for target tasks, thus the practicality of the above method is low.

### SUMMARY OF THE INVENTION

According to an aspect of the present disclosure, a prompt tuning method is provided. The prompt tuning method includes receiving an original prompt input by a user; guiding a first model to start a question answering process based on the original prompt, and requesting the first model to answer the original prompt according to the original prompt and context information obtained in the question answering process, the question answering process including at least one of a process where the first model asks a question and the second model answers the question, and a process where the first model asks a question and answers the question; and obtaining the answer to the original prompt generated by the first model.

According to another aspect of the present disclosure, a prompt tuning apparatus is provided. The prompt tuning apparatus includes a memory storing computer-executable instructions; and one or more processors. The one or more processors are configured to execute the computer-executable instructions such that the one or more processors are configured to receive an original prompt input by a user; guide a first model to start a question answering process based on the original prompt, and request the first model to answer the original prompt according to the original prompt and context information obtained in question answering the process, the question answering process including at least one of a process where the first model asks a question and the second model answers the question, and a process where the first model asks a question and answers the question; and obtain the answer to the original prompt generated by the first model.

According to another aspect of the present disclosure, a non-transitory computer-readable recording medium having computer-executable instructions for execution by one or more processors is provided. The computer-executable instructions, when executed, cause the one or more processors to carry out a prompt tuning method. The prompt tuning method includes receiving an original prompt input by a user; guiding a first model to start a question answering process based on the original prompt, and requesting the first model to answer the original prompt according to the original prompt and context information obtained in the question answering process, the question answering process including at least one of a process where the first model asks a question and the second model answers the question, and a process where the first model asks a question and answers the question; and obtaining the answer to the original prompt generated by the first model.

### BRIEF DESCRIPTION OF THE DRAWINGS

The above and other objects, features and advantages of the present disclosure will be further clarified in light of the following detailed description of embodiments of the present disclosure in combination with the drawings. Note that the accompanying drawings in the following description are only some embodiments of the present disclosure, and for those skilled in the art, other drawings may also be obtained according to these drawings without paying creative labor.

FIG. 1 is a flowchart illustrating an example of a prompt tuning method according to an embodiment of the present disclosure.

FIG. 2 is a schematic diagram of prompt templates in a first method according to embodiment of the present disclosure.

FIG. 3 is a schematic diagram of the inputting of the optimized prompts in the first method according to the embodiment of the present disclosure.

FIG. 4 is a schematic diagram of the effect of an example using the prompt tuning method compared to an example not using the prompt tuning method according to the embodiment of the present disclosure.

FIG. 5 is a schematic diagram of prompt templates in a third method according to the embodiment of the present disclosure.

FIG. 6 is a schematic diagram of the inputting of the optimized prompts in the third method according to the embodiment of the present disclosure.

FIG. 7 is a schematic diagram of a prompt template in the sixth method according to the embodiment of the present disclosure.

FIG. 8 is a schematic diagram of the inputting of the optimized prompt in the sixth method according to the embodiment of the present disclosure.

FIG. 9 is a schematic diagram of an example of a configuration of a prompt tuning apparatus according to another embodiment of the present disclosure.

FIG. 10 is a schematic diagram of an example of a configuration of a prompt tuning apparatus according to another embodiment of the present disclosure.

FIG. 11 is a block diagram illustrating an example of a configuration of prompt tuning apparatus according to another embodiment of the present disclosure.

### DESCRIPTION OF THE EMBODIMENTS

In the following, specific embodiments of the present disclosure will be described in detail with reference to the accompanying drawings, so as to facilitate the understanding of technical problems to be solved by the present disclosure, technical solutions of the present disclosure, and advantages of the present disclosure. The present disclosure is not limited to the specifically described embodiments, and various modifications, combinations and replacements may be made without departing from the scope of the present disclosure. In addition, descriptions of well-known functions and constructions are omitted for clarity and conciseness.

Note that “one embodiment” or “an embodiment” mentioned in the present specification means that specific features, structures or characteristics relating to the embodiment are included in at least one embodiment of the present disclosure. Thus, “one embodiment” or “an embodiment” mentioned in the present specification may not be the same embodiment. Additionally, these specific features, structures or characteristics may be combined in any suitable manner in one or more embodiments. The terms “first”, “second” and the like in the specification and claims of the present disclosure are used to distinguish similar objects, and are not used to describe a specific order or sequence. Note that the data used in this way may be interchangeable where appropriate, so that the embodiments of the present disclosure described here may be implemented in an order other than those illustrated or described here. In addition, the terms “include” and “have” and any of their variations are intended to cover non-exclusive inclusions, for example, a process, method, system, product or device that includes a series of steps or units is not limited to those steps or units that are clearly listed, but may include other steps or units that are not clearly listed or inherent to these processes, methods, products or devices. “And/or” in the specification and claims represents at least one of the connected objects.

Note that steps of the methods may be performed in sequential order, however the order in which the steps are performed is not limited to a sequential order. Further, the described steps may be performed in parallel or independently.

The following description provides examples and does not limit the scope, applicability or configuration set forth in the claims. Modification may be made to the functions and arrangements of the elements discussed without departing from the spirit and scope of the present disclosure. Various examples may appropriately omit, replace, or add various procedures or components. For example, the described method may be performed in an order different from that described, and various steps may be added, omitted, or combined. In addition, the features described with reference to certain examples may be combined in other examples.

Currently, many companies employ humans to perform prompt tuning tasks. The embodiments of the present disclosure mainly discuss automated prompt tuning technology. Automated prompt tuning technology refers to a process of improving and optimizing an original prompt by using computer programs and algorithms, and the original prompt refers to description of a specified task that is input by a user and is to be completed by a target large model. The target large model finally outputs the optimized prompt. In order to realize the ultimate goal of prompt tuning, that is, to improve the accuracy of the response of the large model to the original prompt from the user (or to make the generated content meet the expectations of the user), the embodiments of the present disclosure propose a prompt tuning method based on machine-to-machine interaction, using an agent module to guide the target large model (the first model) to ask a question to the original prompt and answer the question as additional information, thereby improving the quality of the final output of the target large model (the first model).

The automated prompt tuning method of the conventional technology mainly uses another or the same large model to optimize the prompts used in the target large model, and is divided into methods with model training and methods without model training.

In the methods without model training, artificial templates and input/output pair data of the target task from the user are used to make a large model generate prompt candidates, and then the evaluation data is used to evaluate the prompt candidates for the target large model and the optimal prompt is select. By using the method, the difficulty of constructing original prompt can be avoided at the beginning, and the effectiveness of the optimal prompt on the target task can be ensured by using the evaluation data to conduct rigorous evaluation through the target large model. However, the tasks specified by individual users are various, and the users cannot provide input/output data in most of cases. Even if such data is provided, the computing resources and time cost of optimizing prompts for each user-specified task are too high and difficult to implement.

In the methods with model training, gradient-based prompt optimization methods are proposed. However, as the scale of the large models increases, the computing cost also increases significantly. On the other hand, the large models such as ChatGPT are provided in a form of APIs, which only receive text input and do not support gradient acquisition. In addition, the optimal prompts generated by such methods are often abstract and incomprehensible to humans, and the prompt optimization process lacks interpretability. The method proposed in the embodiment of the present disclosure can solve the problems of the above methods. Namely, in the embodiment of the present disclosure, it is unnecessary for a user to provide data, and it is convenient for optimizing the original prompt for the variable specified tasks. Furthermore, model training is not involved, thus the costs is low and the interpretability can be ensured.

Many attempts on large models have shown that the failure to obtain the expected output using a large model may not be due to the poor performance of the large model itself, but due to the prompt tuning skills of the user. Namely, the original prompt input by the user may have problems such as vague task descriptions and lack of details, which often lead to the large model asking questions or generating unhelpful outputs. Furthermore, although the large model has learned a large amount of knowledge, it sometimes lacks the guidance of logical thinking and cannot call these knowledge, resulting in the generation of erroneous or inaccurate outputs.

In view of the above two reasons, in the embodiment of the present disclosure, an additional prompt tuning apparatus (also referred to as an agent module) between the user and the target large model is added to process and forward the interactive information between the user and the target large model. The prompt tuning apparatus guides the target large model to ask a question and answer the question in response to the original prompt from the user, and the answer provide additional information as the context of the final answer of the target large model. The process of the prompt tuning apparatus guiding the target large model to ask and answer the question is an interactive process between machines. The process can clarify the task objectives, fill in details, guide logical thinking, thus the quality of the final answer of the target large model can be improved.

In view of the problem of the conventional technology, an object of the embodiments of the present disclosure is to provide a prompt tuning method, a prompt tuning apparatus, and a non-transitory computer-readable recording medium, which can improve the accuracy of the response of the large language model and enhance the user experience by tuning the original prompt input by the user.

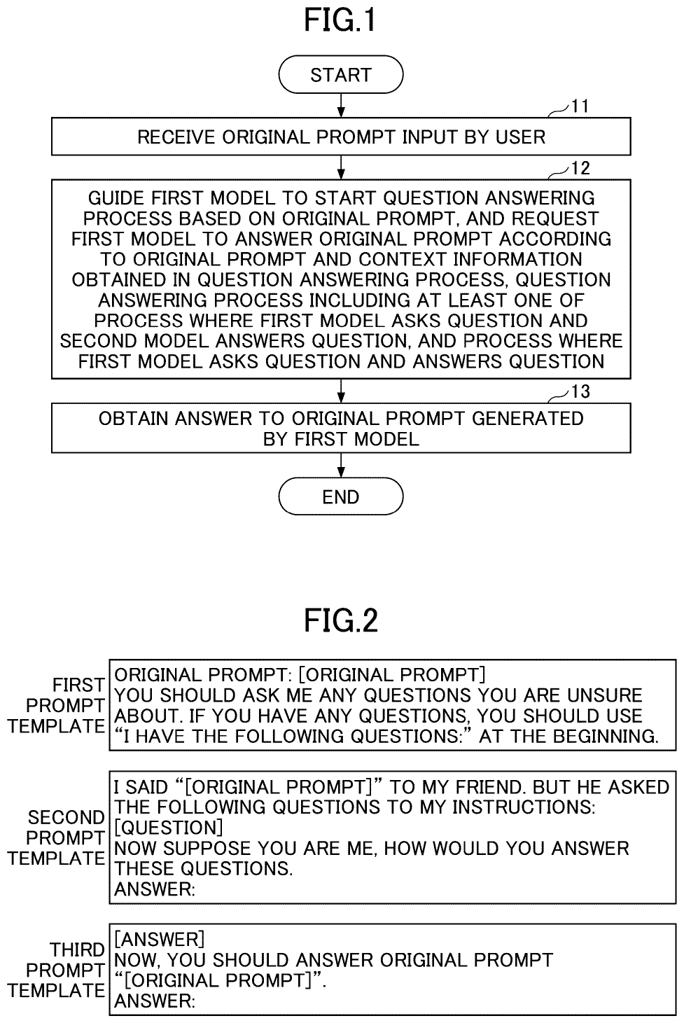

In an embodiment of the present disclosure, a prompt tuning method is provided. FIG. 1 is a flowchart illustrating an example of a prompt tuning method according to an embodiment of the present disclosure. As shown in FIG. 1, the prompt tuning method includes steps 11 to 13.

In step 11, an original prompt input by a user is received.

Here, when the user uses the large language model to generate the content what the user needs, the user usually inputs the original prompt to the large language model. The original prompt is usually a text in natural language, which is used to describe the specific needs of the user. For example, the original prompt may be “please help me arrange a holiday plan in Japan”, “please help me write a year-end summary” or the like. Alternatively, the user may also input the original prompt by voice. In this case, the original prompt input by the user may be obtained by converting a voice signal into a corresponding text.

In step 12, a first model is guided to start a question answering s based on the original prompt, and the first model is requested to answer the original prompt according to the original prompt and context information obtained in the question answering process. The question answering process includes at least one of a process where the first model asks a question and the second model answers the question, and a process where the first model asks a question and answers the question.

Here, in the embodiment of the present disclosure, a prompt template is preset. The prompt template is used to guide the first model to start a question answering process based on the original prompt, and to request the first model to answer the original prompt according to the original prompt and the context information obtained in the question answering process.

In the embodiment of the present disclosure, the question answering process may be the process where the first model asks a question and another model (the second model) answers the question. In this way, the first model can obtain context information related to the original prompt according to the answer of the second model, and then answer the original prompt based on the context information.

In the embodiment of the present disclosure, the question answering process may also be the process where the first model asks a question and answers the question. That is, the first model obtains context information related to the original prompt by asking and answering itself, and then answers the original prompt based on the context information.

Specifically, in step 12, in the embodiment of the present disclosure, an optimized prompt is generated according to the original prompt and a preset prompt template, and the optimized prompt is input into the first model. The prompt template is used to guide the first model to start the question answering process according to the original prompt, and to request the first model to answer the original prompt according to the original prompt and the context information obtained in the question answering process.

In step 13, the answer to the original prompt generated by the first model is obtained.

Here, in the embodiment of the present disclosure, the answer to the original prompt output by the first model may be received and displayed. The specific display method includes but is not limited to at least one of displaying the answer to the original prompt (for example, displaying the answer in text), playing the answer to the original prompt by voice and the like.

Compared to the implementation method of directly requesting the first model to answer the original prompt, in the embodiment of the present disclosure, the first model is guided to start the question answering process based on the content of the original prompt, so that the context information obtained in the question answering process can be used to assist the first model in answering the original prompt. Thus, the first model can generate a more accurate answer based on the context information when answering the original prompt, thereby improving the user experience.

The above method according to the embodiment of the present disclosure can be applied to an automatic question-answering system based on a large language model, so that the system can tune the original prompt input by the user in the backend, thereby improving the accuracy of the response of the automatic question-answering system and improving the user experience.

In the following, the details of several implementation methods for generating the optimized prompts based on the original prompt and the preset prompt templates in step 12 according to the embodiment of the present disclosure will be described.

### [First Method]

In a first method, three prompt templates, namely a first prompt template, a second prompt template and a third prompt template are introduced. FIG. 2 is a schematic diagram of the three prompt templates in the first method according to embodiment of the present disclosure. The templates include at least one placeholder, at least one keyword, and task description content, respectively. Each placeholder corresponds to a content to be filled in. In FIG. 2, “[ ]” represents the placeholder, and the content in “[ ]” represents the content to be filled in corresponding to the placeholder. For example, “[original prompt]” indicates that the content to be filled in corresponding to the placeholder is the original prompt, that is, the original prompt input by the user is filled in the position corresponding to the placeholder, thereby generating a corresponding optimized prompt. The keyword is used to indicate a text structure adopted by the model when providing an answer. For example, the first prompt template uses the keyword “I have the following questions:” to indicate the text structure used by the first model when providing questions, and the second and third prompt templates include the keyword “answer:”. In this way, after obtaining the answer provided by the model, the required answer content can be easily extracted from the answer based on the keyword. The task description content is used to indicate a task to be performed by the model. For example, the task description content in the first prompt template “you should ask me any questions you are unsure about. If you have any questions, you should use ‘I have the following questions:’” is used to request the first model to ask a question based on the content of the original prompt. The task description content in the second prompt template “now suppose you are me, how would you answer these questions” is used to request the second model to answer the question. The task description content in the third prompt template “now, you should answer the original prompt ‘[original prompt]’” is used to request the first model to answer the original prompt.

Since the model is usually able to obtain the context information in the question answering process and perform subsequent tasks based on the context information, the content of the above templates may also be further simplified. For example, the third prompt template may not contain the original prompt. In addition, note that although the specific structure and content of the first, second and third prompt templates are provided in the embodiment of the present disclosure, the above structure and content are not used to limit the present disclosure. Any information that can provide relevant information to the model and trigger the model to perform corresponding tasks may be applied to the present disclosure.

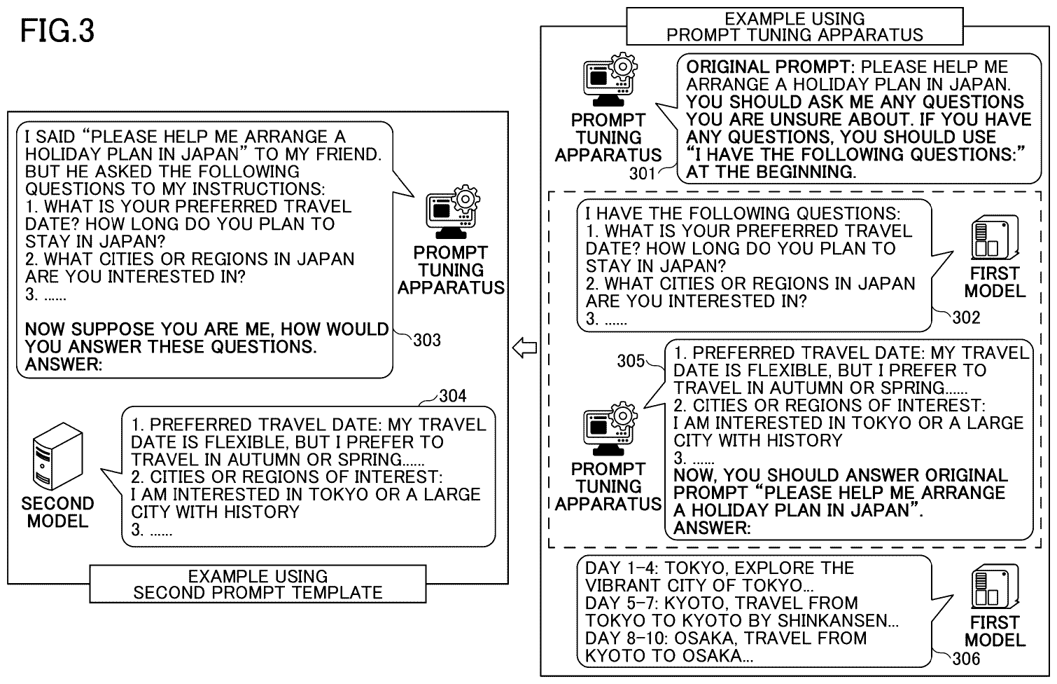

FIG. 3 is a schematic diagram of the inputting of the optimized prompts in the first method.

Specifically, step 12 includes steps 1201 to 1203.

In step 1201, a first optimized prompt is generated according to the original prompt and the preset first prompt template, and the first optimized prompt is input into the first model to obtain at least one question output by the first model. The first prompt template is used to prompt the original prompt, and to request the first model to ask a question according to the original prompt.

Here, the function of the first prompt template is to prompt the content of the original prompt to the first model, and to guide the target large model to ask questions based on the content of the original prompt. According to experimental verification, these questions may include at least one of questions for confirming details in the original prompt, questions for requesting explanations of the instruction content in the original prompt, and questions for requesting external knowledge.

For example, in a case where the original prompt is “please help me arrange a holiday plan in Japan”, the first model may ask “how long do you plan to stay in Japan?” to confirm the details. In a case where the original prompt is “does the following sentence contain a tense error: . . . ?”, the first model may ask “what does a tense error mean?”. In a case where the original prompt is “please write a poem in the style of Shakespeare”, the first model may ask “how many lines does poems of Shakespeare usually have?” to confirm the details. These questions reflect the aspects considered by the large language model to generate the contents that meet the expectations of the user and to avoid errors. A positive impact on the final output of the large model can be realized by answering these questions.

The first prompt template shown in FIG. 2 includes a placeholder corresponding to the original prompt, and includes the task description content “you should ask me any questions you are unsure about. if you have any questions, you should use ‘I have the following questions:’ at the beginning”. The above text content is used to request the first model to ask questions based on the content of the original prompt. In this way, the original prompt is filled into the first prompt template shown in FIG. 2, and a first optimized prompt 301 shown in FIG. 3 can be generated. The first optimized prompt 301 is input into the first model to obtain at least one question output by the first model, such as a question 302 shown in FIG. 3.

In step 1202, a first intermediate prompt is generated according to the original prompt, the at least one question and a preset second prompt template, and first intermediate prompt is input into the second model to obtain an answer output by the second model. The second prompt template is used to prompt the original prompt to the second model, and to request the second model to answer the question.

Here, the function of the second prompt template is to prompt the questions asked by the first model to the second model, and to request the second model to answer the questions. In order to make the second model answer the questions involving human preferences, the second prompt template requests the second model to answer the questions in a human tone by asking using “suppose you are me”.

The second prompt template shown in FIG. 2 includes a placeholder corresponding to the original prompt, a placeholder corresponding to the at least one question, and a task description content “now suppose you are me, how would you answer these questions”. The above text content is used to prompt the at least one question to the second model and request the second model to answer. The second model is any model that can generate answers based on questions. The second model and the first model may be the same large language model. Alternatively, the second model may also be another model different from the first model. The second model may be a large language model such as ChatGPT, ChatGLM, and may also be a question answering model based on document recall, a question answering model based on knowledge recall, a large language model API provided by a third party or another organization, an open source large model, a large language model fine-tuned with own domain data, and the like, which are not specifically limited in the embodiment of the present disclosure. For example, if the second model is a large language model, a first intermediate prompt 303 shown in FIG. 3 may be generated by filling the original prompt and the at least one question into the second prompt template shown in FIG. 2. The first intermediate prompt 303 is input into the second model to obtain at least one answer output by the second model, such as an answer 304 shown in FIG. 3. For another example, if the second model is a traditional question answering model, the at least one question may be input into the second model to obtain the answer output by the second model. Specifically, the question may be input into the second model each time, and the answer to the question output by the second model may be obtained.

In step 1202, the processing of generating the first intermediate prompt according to the original prompt, the at least one question and the preset second prompt template, and inputting the first intermediate prompt into the second model to obtain at least one answer output by the second model may specifically include any one of the following cases.

Case 1: fill the original prompt and the questions output by the first model into the second prompt template, generate the first intermediate prompt and input the first intermediate prompt into the same second model, and obtain the answers output by the second model.

In case 1, only one second model is set, and the second model answers all questions output by the first model. In a case where the second model can answer a plurality of questions at one time, the original prompt and all questions output by the first model may be filled into the second prompt template, the first intermediate prompt may be generated and input into the same second model, and the answers output by the second model may be obtained. In a case where the second model can only answer one question at one time, the original prompt and one question output by the first model may be filled into the second prompt template each time, the first intermediate prompt may be generated and input into the same second model, and the answer output by the second model may be obtained, and the above steps may be repeated multiple times, so that the second model can obtain the answers to all questions output by the first model.

For example, continuing the above example of “please help me arrange a holiday plan in Japan”, assuming that the first model asks three questions, namely, question A “which scenic spots in Japan are you interested in”, question B “do you like cultural scenic spots or natural scenic spots” and question C “which hotels do you want to stay in”, the same second model may answer these three questions. The second model may answer these three questions at once, and may also answer these three questions in three times, namely, answer one question each time.

Case 2: determine a category to which each question output by the first model belongs, fill the original prompt and the questions belonging to the same category into the second prompt template, generate the first intermediate prompt and input the first intermediate prompt into the second model corresponding to the same category, and obtain the answer output by the second model corresponding to the same category. There are a plurality of second models, each of which corresponds to a different category. The question category corresponding to a second model may be one or more.

In case 2, a plurality of second models are preset, each of which corresponds to a different category of questions and can answer questions of respective categories. That is, in the embodiment of the present disclosure, the corresponding second model for different categories of questions are pre-trained, and each second model can answer questions of the respective categories. Thus, in case 2, the categories to which the questions output by the first model belong are first determined, and then the original prompt and the questions belonging to the same category are filled into the second prompt template, the first intermediate prompt is generated and input into the second model corresponding to the same category, and the answer output by the second model corresponding to the same category is obtained. Similarly, according to the capability of the second model, a plurality of questions belonging to the same category may be answered at one time, or only one question belonging to the same category may be answered each time.

Continuing the above example, question A “which scenic spots in Japan are you interested in” and question B “do you like cultural scenic spots or natural scenic spots” are questions related to scenic spots, assuming that their categories are scenic spots, and question C “which hotels do you want to stay in” is a question related to accommodation, assuming that its category is accommodation. Assume that two second models are pre-trained, which correspond to scenic spots and accommodation, respectively. Then, questions A and B may be filled into the second prompt template, the first intermediate prompt is generated and is input into the second model corresponding to the scenic spot, and the answer output by the model is obtained. question C may be filled into the second prompt template, the first intermediate prompt is generated and is input into the second model corresponding to the accommodation, and the answer output by the model is obtained.

In step 1203, a second optimized prompt is generated according to the original prompt, the answer output by the second model and a third prompt template, and second optimized prompt is input into the first model. The third prompt template is used to prompt the original prompt and the answer output by the second model to the first model, and to request the first model to answer the original prompt.

Here, the function of the third prompt template is to forward the answer content of the second model to the first model, and prompt the original prompt to the first model and request the first model to answer the original prompt again. Since the first model may have a context truncation mechanism, that is, in a case where the current input and the dialogue history exceed a maximum input length specified by the model, the model may truncate the dialogue history, which may cause the first model to forget the original prompt from the user. Therefore, the third prompt template can avoid the above case by prompting the content of the original prompt to the first model again.

Continuing the above example, the original prompt and the at least one answer 304 are filled into the third prompt template shown in FIG. 2, and a second optimized prompt 305 shown in FIG. 3 may be generated. The second optimized prompt 305 is input into the first model to obtain the answer to the original prompt output by the first model, such as an answer 306 shown in FIG. 3.

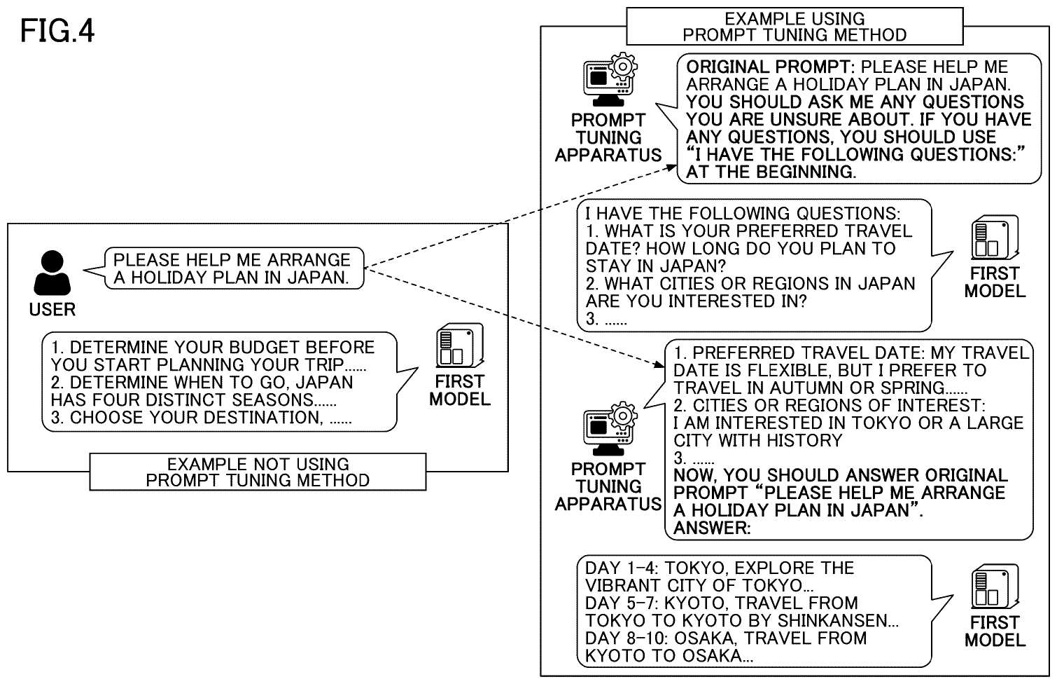

FIG. 4 is a schematic diagram of the effect of an example using the prompt tuning method compared to an example not using the prompt tuning method according to the embodiment of the present disclosure. The left side shows a real example not using the prompt tuning method according to the embodiment of the present disclosure. In this example, for the original prompt from the user “please help me arrange a holiday plan in Japan”, the first model generates an answer. After analysis, the answer only prompts the user to consider the aspects of the travel, but does not list a complete plan according to the requirements of the user, which have no use for the user. The right side shows an example using the prompt tuning method according to the embodiment of the present disclosure. In this example, the first model asks questions from a plurality of aspects such as travel date, travel days, and destination for the original prompt to confirm the details, and then answers these questions one by one through the second model. These answers provide references as the context of the final answer of the first model, so that the first model finally outputs a rich travel plan that meets the requirements of the user. It can be seen that the answer obtained by the embodiment of the present disclosure is more meet the expectations of the user. That is, in the embodiment of the present disclosure, the accuracy of the response of the large language model to the original prompt and the user experience can be improved.

### [Second Method]

In a second method, the same three prompt templates as the first method, namely, the first prompt template, the second prompt template, and the third prompt template are also introduced. Considering the capabilities of the second model, there may be questions that the second model cannot answer, and the second method distinguishes and processes this case.

Specifically, step 12 includes steps 1211 to 1215.

In step 1211, a first optimized prompt is generated according to the original prompt and a preset first prompt template, and the first optimized prompt is input into the first model to obtain at least one question output by the first model. The first prompt template is used to prompt the original prompt, and to request the first model to ask a question according to the original prompt.

In step 1212, it is determined whether the at least one question is a first question or a second question. The first question is a question which can be answered by the second model, and the second question is a question which cannot be answered by the second model.

Here, the second model corresponds to a specific question category and can answer questions under the category. In a case where a question does not belong to the category corresponding to the second model, the second model cannot answer the question. Thus, it may be determined whether the second model can answer these questions based on the categories to which the various questions asked by the first model belong, thereby dividing the various questions asked by the first model into the first questions and the second questions. In addition, similar to the first method, there may be one or more second models. The question category corresponding to the second model may be one or more.

In addition, in the embodiment of the present disclosure, the correspondence between the question category and whether to ask the user may be pre-saved. For example, for questions whose category is user attributes (for example, the age and gender of the user), it is set that such questions need to be asked to the user. For the questions which can be answered by the second model, it is set that such questions do not need to be asked to the user. In this way, the various questions asked by the first model can also be divided into the first questions and the second questions.

Specifically, in the embodiment of the present disclosure, the category to which the question belongs may be determined according to the keyword contained in the question and its context information.

In step 1213, for the first question, a second intermediate prompt is generated according to the original prompt, the first question and a preset second prompt template, and the second intermediate prompt is input into the second model to obtain an answer output by the second model. The second prompt template is used to prompt the original prompt to the second model, and to request the second model to answer the first question.

Here, step 1213 is similar to step 1202 of the first method. For the first question, the second intermediate prompt is generated through the second prompt template and input into the second model, so as to obtain the answer of the second model to the first question. Similarly, step 1213 may also include any one of the following cases.

Case 1: fill the original prompt and the first question into the second prompt template, generate the second intermediate prompt and input the second intermediate prompt into the same second model, and obtain the answer output by the second model. Case 1 corresponds to a scenario where only one second model is set.

Case 2: determine the category to which each question among the first questions belongs, fill the original prompt and the question belonging to the same category into the second prompt template, generate the second intermediate prompt and input the second intermediate prompt into the second model corresponding to the same category, and obtain the answer output by the second model corresponding to the same category. There are a plurality of second models, each of which corresponds to a different category. Case 2 corresponds to a scenario where a plurality of second models are set, each of which corresponds to a different category. The question category corresponding to a second model may be one or more.

In step 1214, for the second question, the second question is prompted to a user, and an answer input by the user is received.

Here, the second question is prompted to the user, and the answer input by the user to the second question is received. For example, suppose that the questions asked by the first model further include question D “your age”, question E “your gender” and the like. These questions belong to the category of “user attributes”, which are the second questions and need to be asked to the user to obtain answers. Specifically, in the embodiment of the present disclosure, the second questions may be displayed, and relevant answers input by the user may be received.

In step 1215, a third optimized prompt is generated according to the original prompt, a first answer and a third prompt template, and the third optimized prompt is input into the first model. The third prompt template is used to prompt the original prompt and the first answer to the first model, and to request the first model to answer the original prompt. The first answer includes at least one of the answer output by the second model, and the answer input by the user.

Here, in step 1215, the second optimized prompt is generated according to at least one of the answer output by the second model, and the answer input by the user, and the second optimized prompt is input into the first model to request the first model to answer the original prompt according to these answers.

### [Third Method]

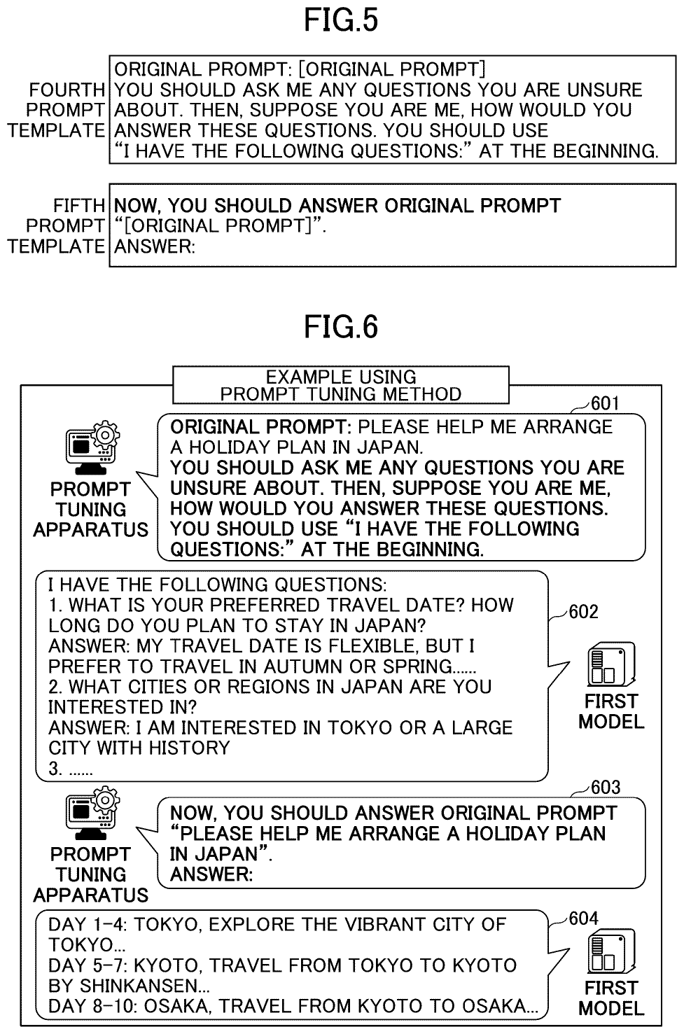

In a third method, two prompt templates are introduced, respectively referred to as a fourth prompt template and a fifth prompt template. FIG. 5 is a schematic diagram of the two prompt templates in the fourth prompt a third method. Similarly, template and the fifth prompt template include at least one placeholder, respectively. Each placeholder corresponds to a prompt content. FIG. 6 is a schematic diagram of an example of the inputting of the optimized prompts into the first model in the third method.

Specifically, step 12 includes step 1221 and 1222.

In step 1221, a fourth optimized prompt is generated according to the original prompt and the preset fourth prompt template, and the fourth optimized prompt is input into the first model to obtain an answer output by the first model. The fourth prompt template is used to prompt the original prompt, and to request the first model to ask a question and output the answer according to the original prompt.

In the above first method, the first model asks questions and the second model answers. In the third method, the first model asks questions and the first model answers, that is, both the questions and the answers are processed by the first model. Continuing the above example, the original prompt may be filled into the fourth prompt template to generate a fourth optimized prompt 601 shown in FIG. 6. The fourth optimized prompt 601 requests the first model to ask questions and answer the original prompt. The fourth optimized prompt 601 is input into the first model to obtain at least one answer 602 output by the first model. The first model may be any large language model that can generate answers based on prompts, such as ChatGPT, ChatGLM and the like, and the embodiment of the present disclosure does not limited to these models.

In step 1222, a fifth optimized prompt is generated according to the original prompt and the fifth prompt template, and the fifth optimized prompt is input into the first model. The fifth prompt template is used to prompt the original prompt to the first model, and to request the first model to answer the original prompt.

Here, a fifth optimized prompt 603 shown in FIG. 6 may be generated by filling the original prompt into the fifth prompt template. The fifth optimized prompt 603 requests the first model to ask and answer questions for the original prompt. The first model has been requested to ask and answer questions for the original prompt and to generate at least one pair of questions and answers in the interaction process of step 1221. Thus, in the subsequent steps, after receiving the fourth optimized prompt, the first model will answer the original prompt according to at least one pair of questions and answers generated in the previous interaction process, and generate an answer 604, thereby improving the accuracy of the answer generated by the first model and improving the user experience.

The implementation method of the above third method can avoid using the second model, thereby reducing the number of model inferences.

### [Fourth Method]

In a fourth method, a second prompt template similar to the first method and a fourth prompt template and a fifth prompt template similar to the third method are used. The fourth method considers the case that the first model may not be able to answer the questions asked by the first model. For this case, step 12 includes steps 1231 to 1233.

In step 1231, a fourth optimized prompt is generated according to the original prompt and a preset fourth prompt template, and the fourth optimized prompt is input into the first model to obtain an answer output by the first model. The fourth prompt template is used to prompt the original prompt, and to request the first model to ask a question and output the answer according to the original prompt.

In step 1232, in a case where the answer output by the first model includes at least one third question which cannot be answered by the first model, a third intermediate prompt is generated according to the original prompt, the at least one third question and a preset second prompt template, and the third intermediate prompt is input into the second model to obtain an answer output by the second model. The second prompt template is used to prompt the original prompt to the second model, and to request the second model to answer the third question.

Here, in the scenario where the first model cannot answer the question asked by the first model, the answer output by the first model contains relevant prompt information, for example, prompting one or more questions that cannot be answered by the first model (for the convenience of the description, referred to as the third question). In this way, in a case where the answer output by the first model includes at least one third question that cannot be answered by the first model, the at least one third question that cannot be answered by the first model may be extracted according to the above prompt information.

For example, in the embodiment of the present disclosure, the questions that cannot be answered by the first model may also be obtained by adding the content “If you have questions that cannot be answered, you should ask me questions starting with ‘I have questions that cannot be answered:’” to the fourth prompt template.

In this way, in step 1232, it can be determined whether the first model has questions that cannot be answered, according to whether the answer output by the first model contains the keyword “I have questions that cannot be answered:”. In a case where the first model has questions that cannot be answered, the questions that cannot be answered by the first model are extracted according to the above keywords.

Then, after extracting the third question that cannot be answered by the first model, the third question may be answered by the external second model. In this case, the third question is filled into the second prompt template to obtain the third intermediate prompt, and the third intermediate prompt is input into the second model.

Similarly, there may be one or more second models. The first intermediate prompt is generated according to the original prompt, the at least one third question and the preset second prompt template, and the first intermediate prompt is input into the second model to obtain the answer output by the second model. Specifically, any one of the following cases may be included.

Case 1: fill the original prompt and each third question into the second prompt template, generate the third intermediate prompt and input the third intermediate prompt into the same second model, and obtain the answer output by the second model.

Case 2: determine the category to which each third question belongs, fill the original prompt and the third question belonging to the same category into the second prompt template, generate the third intermediate prompt and input the third intermediate prompt into the second model corresponding to the same category, and obtain the answer output by the second model corresponding to the same category. There are a plurality of second models, and each second model corresponds to a different category.

In step 1233: a sixth optimized prompt is generated according to the original prompt, a second answer and a third prompt template, and the sixth optimized prompt is input into the first model. The third prompt template is used to prompt the original prompt and the second answer to the first model, and to request the first model to answer the original prompt. The second answer includes at least one of the answer output by the second model, and the answer of the first model to at least one fourth question. The fourth question is a question which can be answered by the first model.

In this case, since the answers to some questions may be obtained from the second model, the fifth prompt template may be modified to replace the original answer of the first model. For example, it may be modified to the form “Now, you should answer the original prompt ‘please help me arrange a holiday plan in Japan.’ But please replace the answer to question 3 . . . with [answer]. Answer:”. Here, the content of the [answer] part is the answer of the second model.

Alternatively, in the embodiment of the present disclosure, a new prompt template may also be added to replace the original answer of the first model.

### [Fifth Method]

Based on the fourth method, the fifth method further considers the case that one or some questions asked by the first model cannot be answered by the second model and need to be answered by the user (similar to the second method). For this case, step 12 includes steps 1241 to 1245.

In step 1241, a fourth optimized prompt is generated according to the original prompt and a preset fourth prompt template, and the fourth optimized prompt is input into the first model to obtain an answer output by the first model. The fourth prompt template is used to prompt the original prompt, and to request the first model to ask a question and output the answer according to the original prompt.

In step 1242, in a case where the answer output by the first model includes at least one third question which is asked by the first model and cannot be answered by the first model, it is determined whether the at least one third question is a first question or a second question. The first question is a question which can be answered by the second model, and the second question is a question which cannot be answered by the second model.

In step 1243, for the first question, a fourth intermediate prompt is generated according to the original prompt, the first question and a preset second prompt template, and the fourth intermediate prompt is input into the second model to obtain an answer output by the second model. The second prompt template is used to prompt the original prompt to the second model, and to request the second model to answer the first question.

Similarly, there may be one or more second models. The fourth intermediate prompt is generated according to the original prompt, the third question and the preset second prompt template, and the fourth intermediate prompt is input into the second model to obtain the answer output by the second model. Specifically, any one of the following cases may be included.

Case 1: fill the original prompt and the third question into the second prompt template, generate the fourth intermediate prompt and input the fourth intermediate prompt into the same second model, and obtain the answer output by the second model.

Case 2: determine the category to which each third question belongs, fill the original prompt and the third questions belonging to the same category into the second prompt template, generate the fourth intermediate prompt and input the fourth intermediate prompt into the second model corresponding to the same category, and obtain the answer output by the second model corresponding to the same category. There are a plurality of second models, and each second model corresponds to a different category.

In step 1244, for the second question, the second question is prompted to a user, and an answer input by the user is received.

In step 1245, a seventh optimized prompt is generated according to the original prompt, a third answer and a third prompt template, and the seventh optimized prompt is input into the first model. The third prompt template is used to prompt the original prompt and the third answer to the first model, and to request the first model to answer the original prompt. The third answer includes at least one of the answer input by the user, the answer output by the second model, and the answer of the first model to at least one fourth question. The fourth question is a question which is asked by the first model and can be answered by the first model.

In this case, since the answers to some questions may be obtained from at least one of the second model and the user, the fifth prompt template may be modified to replace the original answer of the first model. For example, it may be modified to the form “Now, you should answer the original prompt ‘please help me arrange a holiday plan in Japan.’ But please replace the answer to question 3 . . . with [answer]. Answer:”. Here, the content of the [answer] part is the answer from at least one of the second model and the user.

Alternatively, in the embodiment of the present disclosure, a new prompt template may also be added to replace the original answer of the first model.

In the above first method to fifth method, in step 13, in the embodiment of the present disclosure, the answer to the original prompt output by the first model is received and displayed.

### [Sixth Method]

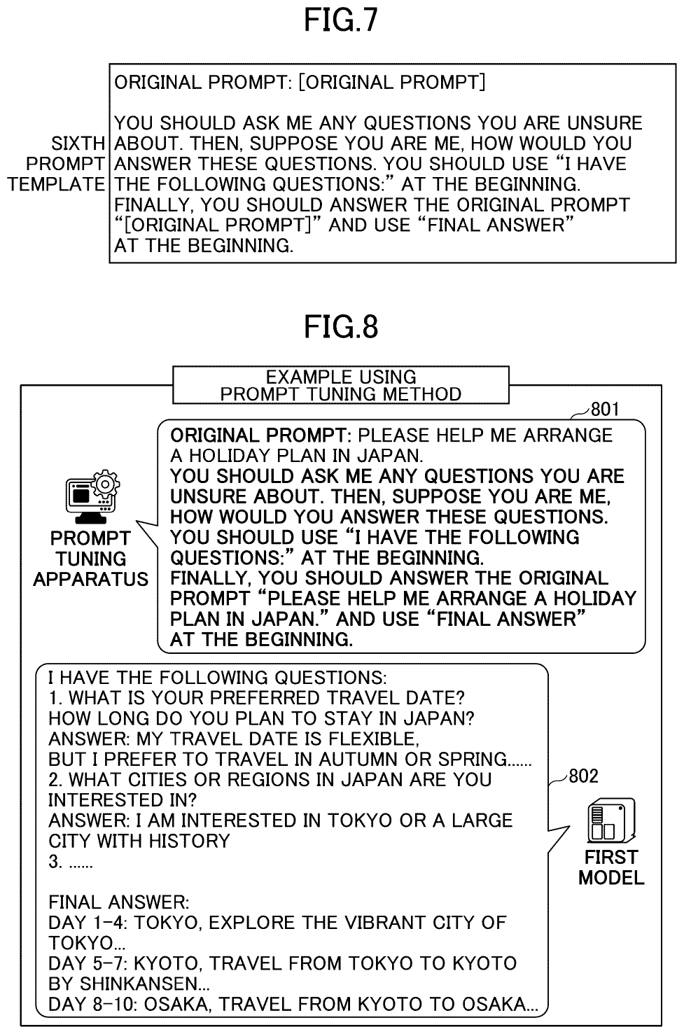

In a sixth method, a prompt template is introduced, which is referred to as a sixth prompt template. Similarly, the sixth prompt template includes at least one placeholder, and each placeholder corresponds to a prompt content. FIG. 7 is a schematic diagram of a prompt template in the sixth method. FIG. 8 is a schematic diagram of the inputting of the optimized prompt into the first model in the sixth method.

Specifically, step 12 includes step 1251.

In step 1251, an eighth optimized prompt is generated according to the original prompt and a sixth prompt template, and the eighth optimized prompt is input into the first model. The sixth prompt template is used to prompt the original prompt, and to request the first model to ask a question and answer the question according to the original prompt, and answer the original prompt.

Here, the original prompt is filled into the sixth prompt template to generate an eighth optimized prompt 801 shown in FIG. 8. The eighth optimized prompt 801 requests the first model to ask questions for the original prompt and answer the questions, and answer the original prompt. The eighth optimized prompt 801 is input into the first model to obtain an answer 802 output by the first model to the original prompt. In the process of answering the original prompt, the first model asks and answers the original prompt according to the requirements of the fifth optimized prompt, and generates at least one pair of questions and answers. Thus, when the first model answers the original prompt, the first model can answer the original prompt according to the content such as at least one pair of questions and answers generated in the previous interaction process, thereby improving the accuracy of the answer generated by the first model and improving the user experience.

In the above sixth method, in the process of the first model generating an answer to the original prompt, there may be questions that cannot be answered by the first model. As an implementation method, in the embodiment of the present disclosure, the second model is used to answer the questions that cannot be answered by the first model. In this case, step 13 specifically includes steps 1301 to 1303.

In step 1301, answer information output by the first model is received.

Here, the answer information output by the first model may include the answer of the first model to the original prompt, and may also include the questions asked by the first model and the answers of the first model to the questions, and may also include questions that be asked by the first model and cannot be answered by the first model.

In step 1302, in a case where the answer information output includes at least one third question which cannot be answered by the first model, a fifth intermediate prompt is generated according to the original prompt, the at least one third question and a preset second prompt template, and the fifth intermediate prompt is input into the second model to obtaining an answer output by the second model. The second prompt template is used to prompt the original prompt to the second model, and to request the second model to answer the third question.

Similarly, in the embodiment of the present disclosure, the questions that cannot be answered by the first model may also be obtained by modifying the sixth prompt template. For example, the questions that cannot be answered by the first model are obtained by adding the content “If you have questions that cannot be answered, you should ask me questions starting with ‘I have questions that cannot be answered:’” to the sixth prompt template.

In this way, in step 1302, it can be determined whether the first model has questions that cannot be answered according to whether the answer output by the first model contains the keyword “I have questions that cannot be answered:”. In a case where the first model has questions that cannot be answered, the questions that cannot be answered by the first model are extracted according to the above keywords.

Here, the process of generating the fifth intermediate prompt according to the original prompt, the at least one third question and the preset second prompt template, and inputting the fifth intermediate prompt into the second model may specifically include any one of the following cases.

Case 1: fill the original prompt and each third question into the second prompt template, generate the fifth intermediate prompt and input the fifth intermediate prompt into the same second model, and obtain the answer output by the second model.

Case 2: determine the category to which each third question belongs, fill the original prompt and the third question belonging to the same category into the second prompt template, generate the fifth intermediate prompt and input the fifth intermediate prompt into the second model corresponding to the same category, and obtain the answer output by the second model corresponding to the same category. There are a plurality of second models, and each second model corresponds to a different category.

In step 1303, a ninth optimized prompt is generated according to the original prompt, a fourth answer and a seventh prompt template, and the ninth optimized prompt is input into the first model. The seventh prompt template is used to prompt the original prompt and the fourth answer to the first model, and to request the first model to answer the original prompt again. The fourth answer includes at least one of the answer output by the second model, and the answer of the first model to at least one fourth question. The fourth question is a question which is asked by the first model and can be answered by the first model.

In the above sixth method, in the process of the first model generating the answer to the original prompt, there may be questions that cannot be answered by the first model. As another implementation method, in the embodiment of the present disclosure, the second model and the user may answer the questions that cannot be answered by the first model. In this case, step 3 specifically includes steps 1311 to 1315.

In step 1311, answer information output by the first model is received.

Here, the answer information output by the first model may include the answer of the first model to the original prompt, and may also include the questions asked by the first model and the answers of the first model to the questions, and may also include questions that be asked by the first model and cannot be answered by the first model.

In step 1312, in a case where the answer information output by the first model includes at least one third question which cannot be answered by the first model, it is determined whether the at least one third question is a first question or a second question. The first question is a question which can be answered by the second model, and the second question is a question which cannot be answered by the second model.

Here, the specific implementation of determining the first question and the second question can refer to the description in the above second method, which will not be repeated here.

In step 1313, for the first question, a sixth intermediate prompt is generated according to the original prompt, the first question and a preset second prompt template, and the sixth intermediate prompt is input into the second model to obtain an answer output by the second model. The second prompt template is used to prompt the original prompt to the second model, and to request the second model to answer the first question.

Here, the process of generating the sixth intermediate prompt according to the original prompt, the first question and the preset second prompt template, and inputting the sixth intermediate prompt into the second model to obtain the answer output by the second model may specifically include any one of the following cases.

Case 1: fill the original prompt and the first question into the second prompt template, generate the sixth intermediate prompt and input the sixth intermediate prompt into the same second model, and obtain the answer output by the second model.

Case 2: determine the category to which each question among the first questions belongs, fill the original prompt and the questions belonging to the same category into the second prompt template, generate the sixth intermediate prompt and input the sixth intermediate prompt into the second model corresponding to the same category, and obtain the answer output by the second model corresponding to the same category. There are a plurality of second models, and each second model corresponds to a different category.

In step 1314, for the second question, the second question is prompted to a user, and an answer input by the user is received.

Here, the specific implementation of step 1314 may refer to the implementation of step 1214 in the above second method, which will not be repeated here.

In step 1315, a tenth optimized prompt is generated according to the original prompt, a fifth answer and a seventh prompt template, and the tenth optimized prompt is input into the first model. The seventh prompt template used to prompt the is original prompt and the fifth answer to the first model, and to request the first model to answer the original prompt again. The fifth answer includes at least one of the answer input by the user, the answer output by the second model, and the answer of the first model to at least one fourth question. The fourth question is a question which can be answered by the first model.

Here, in step 1315, the answer of the first model to the third question is replaced by the newly added seventh prompt template, that is, is replaced by at least one of the answer of the second model and the answer of the user.

In the above sixth method, in a case where the answer information includes the answer of the first model to the original prompt, the answer of the first model to the original prompt is displayed.

Compared to the implementation method of directly requesting the first model to answer the original prompt, in the embodiment of the present disclosure, the first model is guided to start the question answering process based on the content of the original prompt, so that the context information obtained in the question answering process can be used to assist the first model in answering the original prompt. Thus, the first model can generate a more accurate answer based on the context information when answering the original prompt, thereby improving the user experience.

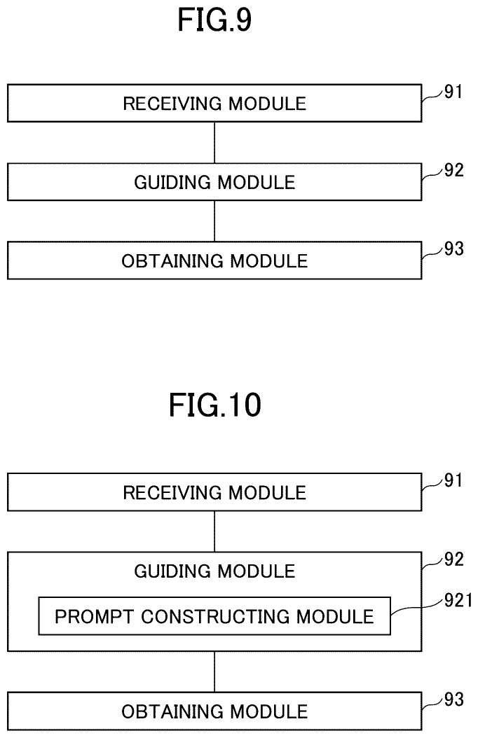

In another embodiment of the present disclosure, a prompt tuning apparatus is further provided. FIG. 9 is a schematic diagram of an example of a configuration of a prompt tuning apparatus according to another embodiment of the present disclosure. As shown in FIG. 9, the prompt tuning apparatus includes a receiving module 91, a guiding module 92, and an obtaining module 93.

The receiving module 91 receives an original prompt input by a user.

The guiding module 92 guides a first model to start a question answering process based on the original prompt, and requests the first model to answer the original prompt according to the original prompt and context information obtained in the question answering process. The question answering process includes at least one of a process where the first model asks a question and the second model answers the question, and a process where the first model asks a question and answers the question.

The obtaining module 93 obtains the answer to the original prompt generated by the first model.

Based on the above modules, the embodiment of the present disclosure can improve the accuracy of the large language model response and enhance the user experience by optimizing the original prompt input by the user.

FIG. 10 is a schematic diagram of an prompt tuning example of a configuration of a apparatus according to another embodiment of the present disclosure. As shown in FIG. 10, the guiding module 92 specifically includes a prompt constructing module 921.

The prompt constructing module 921 generates an optimized prompt according to the original prompt and a preset prompt template, and inputs the optimized prompt into the first model. The prompt template is used to guide the first model to start the question answering process according to the original prompt, and to request the first model to answer the original prompt according to the original prompt and the context information obtained in the question answering process.

Preferably, the prompt constructing module includes a first construction interaction module, a second construction interaction module, and a third construction interaction module.

The first construction interaction module generates a first optimized prompt according to the original prompt and the preset first prompt template, and inputs the first optimized prompt into the first model to obtain at least one question output by the first model. The first prompt template is used to prompt the original prompt, and to request the first model to ask a question according to the original prompt.

The second construction interaction module generates a first intermediate prompt according to the original prompt, the at least one question and a preset second prompt template, and inputs first intermediate prompt into the second model to obtain an answer output by the second model. The second prompt template is used to prompt the original prompt to the second model, and to request the second model to answer the question.

The third construction interaction module generates a second optimized prompt according to the original prompt, the answer output by the second model and a third prompt template, and inputs second optimized prompt into the first model. The third prompt template is used to prompt the original prompt and the answer output by the second model to the first model, and to request the first model to answer the original prompt.

Preferably, the second construction interaction module generates the first intermediate prompt and inputs the first intermediate prompt into the second model to obtain the answer output by the second model by any one of the following methods.

Method 1: fill the original prompt and the questions output by the first model into the second prompt template, generate the first intermediate prompt and input the first intermediate prompt into the same second model, and obtain the answers output by the second model.

Method 2: determine a category to which each question output by the first model belongs, fill the original prompt and the questions belonging to the same category into the second prompt template, generate the first intermediate prompt and input the first intermediate prompt into the second model corresponding to the same category, and obtain the answer output by the second model corresponding to the same category. There are a plurality of second models, each of which corresponds to a different category. The question category corresponding to a second model may be one or more.

Preferably, the prompt constructing module includes a fourth construction interaction module, a first determination module, a fifth construction interaction module, a first user interaction module, and a sixth construction interaction module.

The fourth construction interaction module generates a first optimized prompt according to the original prompt and a preset first prompt template, and inputs the first optimized prompt into the first model to obtain at least one question output by the first model. The first prompt template is used to prompt the original prompt, and to request the first model to ask a question according to the original prompt.

The first determination module determines whether the at least one question is a first question or a second question. The first question is a question which can be answered by the second model, and the second question is a question which cannot be answered by the second model.

For the first question, the fifth construction interaction module generates a second intermediate prompt according to the original prompt, the first question and a preset second prompt template, and inputs the second intermediate prompt into the second model to obtain an answer output by the second model. The second prompt template is used to prompt the original prompt to the second model, and to request the second model to answer the first question.

For the second question, the first user interaction module prompts the second question to a user, and receives an answer input by the user.

The sixth construction interaction module generates a third optimized prompt according to the original prompt, a first answer and a third prompt template, and inputs the third optimized prompt into the first model. The third prompt template is used to prompt the original prompt and the first answer to the first model, and to request the first model to answer the original prompt. The first answer includes at least one of the answer output by the second model, and the answer input by the user.

Preferably, the fifth construction interaction module generates the second intermediate prompt and inputs the second intermediate prompt into the second model to obtain the answer output by the second model by any one of the following methods.

Method 1: fill the original prompt and the first question into the second prompt template, generate the second intermediate prompt and input the second intermediate prompt into the same second model, and obtain the answer output by the second model.

Method 2: determine the category to which each question among the first questions belongs, fill the original prompt and the question belonging to the same category into the second prompt template, generate the second intermediate prompt and input the second intermediate prompt into the second model corresponding to the same category, and obtain the answer output by the second model corresponding to the same category. There are a plurality of second models, each of which corresponds to a different category.

Preferably, the prompt constructing module includes a seventh construction interaction module and an eighth construction interaction module.

The seventh construction interaction module generates a fourth optimized prompt according to the original prompt and the preset fourth prompt template, and inputs the fourth optimized prompt into the first model to obtain an answer output by the first model. The fourth prompt template is used to prompt the original prompt, and to request the first model to ask a question and output the answer according to the original prompt.

The eighth construction interaction module generates a fifth optimized prompt according to the original prompt and the fifth prompt template, and inputs the fifth optimized prompt into the first model. The fifth prompt template is used to prompt the original prompt to the first model, and to request the first model to answer the original prompt.

Preferably, the prompt constructing module includes a ninth construction interaction module, a interaction module, and an tenth construction eleventh construction interaction module.

The ninth construction interaction module generates a fourth optimized prompt according to the original prompt and a preset fourth prompt template, and inputs the fourth optimized prompt into the first model to obtain an answer output by the first model. The fourth prompt template is used to prompt the original prompt, and to request the first model to ask a question and output the answer according to the original prompt.

In a case where the answer output by the first model includes at least one third question which cannot be answered by the first model, the tenth construction interaction module generates a third intermediate prompt according to the original prompt, the at least one third question and a preset second prompt template, and inputs the third intermediate prompt into the second model to obtain an answer output by the second model. The second prompt template is used to prompt the original prompt to the second model, and to request the second model to answer the third question.

The eleventh construction interaction module generates a sixth optimized prompt according to the original prompt, a second answer and a third prompt template, and inputs the sixth optimized prompt into the first model. The third prompt template is used to prompt the original prompt and the second answer to the first model, and to request the first model to answer the original prompt. The second answer includes at least one of the answer output by the second model, and the answer of the first model to at least one fourth question. The fourth question is a question which can be answered by the first model.

Preferably, the tenth construction interaction module generates the third intermediate prompt and inputs the third intermediate prompt into the second model to obtain the answer output by the second model by any one of the following methods.

Method 1: fill the original prompt and each third question into the second prompt template, generate the third intermediate prompt and input the third intermediate prompt into the same second model, and obtain the answer output by the second model.

Method 2: determine the category to which each third question belongs, fill the original prompt and the third question belonging to the same category into the second prompt template, generate the third intermediate prompt and input the third intermediate prompt into the second model corresponding to the same category, and obtain the answer output by the second model corresponding to the same category. There are a plurality of second models, and each second model corresponds to a different category.

Preferably, the prompt constructing module includes twelfth construction interaction module, a second determination module, a thirteenth construction interaction module, a second user interaction module, and a fourteenth construction interaction module.

The twelfth construction interaction module generates a fourth optimized prompt according to the original prompt and a preset fourth prompt template, and inputs the fourth optimized prompt into the first model to obtain an answer output by the first model. The fourth prompt template is used to prompt the original prompt, and to request the first model to ask a question and output the answer according to the original prompt.

In a case where the answer output by the first model includes at least one third question which is asked by the first model and cannot be answered by the first model, the second determination module determines whether the at least one third question is a first question or a second question. The first question is a question which can be answered by the second model, and the second question is a question which cannot be answered by the second model.

For the first question, the thirteenth construction interaction module generates a fourth intermediate prompt according to the original prompt, the first question and a preset second prompt template, and inputs the fourth intermediate prompt into the second model to obtain an answer output by the second model. The second prompt template is used to prompt the original prompt to the second model, and to request the second model to answer the first question.

For the second question, the second user interaction module prompts the second question to a user, and receives an answer input by the user.

The fourteenth construction interaction module generates a seventh optimized prompt according to the original prompt, a third answer and a third prompt template, and inputs the seventh optimized prompt into the first model. The third prompt template is used to prompt the original prompt and the third answer to the first model, and to request the first model to answer the original prompt. The third answer includes at least one of the answer input by the user, the answer output by the second model, and the answer of the first model to at least one fourth question. The fourth question is a question which is asked by the first model and can be answered by the first model.

Preferably, the thirteenth construction interaction module generates the fourth intermediate prompt and inputs the fourth intermediate prompt into the second model to obtain the answer output by the second model by any one of the following methods.

Method 1: fill the original prompt and the third question into the second prompt template, generate the fourth intermediate prompt and input the fourth intermediate prompt into the same second model, and obtain the answer output by the second model.

Method 2: determine the category to which each third question belongs, fill the original prompt and the third questions belonging to the same category into the second prompt template, generate the fourth intermediate prompt and input the fourth intermediate prompt into the second model corresponding to the same category, and obtain the answer output by the second model corresponding to the same category. There are a plurality of second models, and each second model corresponds to a different category.

Preferably, the obtaining module receives and displays the answer to the original prompt output by the first model.

Preferably, the prompt constructing module includes a fifteenth construction interaction module.

The fifteenth construction interaction module generates an eighth optimized prompt according to the original prompt and a sixth prompt template, and inputs the eighth optimized prompt into the first model. The sixth prompt template is used to prompt the original prompt, and to request the first model to ask a question and answer the question according to the original prompt, and answer the original prompt.

Preferably, the obtaining module includes a first receiving module, a sixteenth construction interaction module, and a seventeenth construction interaction module.

The first receiving module receives answer information output by the first model.

In a case where the answer information output includes at least one third question which cannot be answered by the first model, the sixteenth construction interaction module e generates a fifth intermediate prompt according to the original prompt, the at least one third question and a preset second prompt template, and inputs the fifth intermediate prompt into the second model to obtaining an answer output by the second model. The second prompt template is used to prompt the original prompt to the second model, and to request the second model to answer the third question.

The seventeenth construction interaction module generates a ninth optimized prompt according to the original prompt, a fourth answer and a seventh prompt template, and inputs the ninth optimized prompt into the first model. The seventh prompt template is used to prompt the original prompt and the fourth answer to the first model, and to request the first model to answer the original prompt again. The fourth answer includes at least one of the answer output by the second model, and the answer of the first model to at least one fourth question. The fourth question is a question which is asked by the first model and can be answered by the first model.

Preferably, the sixteenth construction interaction module generates the fifth intermediate prompt and inputs the fifth intermediate prompt into the second model to obtain the answer output by the second model by any one of the following methods.

Method 1: fill the original prompt and each third question into the second prompt template, generate the fifth intermediate prompt and input the fifth intermediate prompt into the same second model, and obtain the answer output by the second model.

Method 2: determine the category to which each third question belongs, fill the original prompt and the third question belonging to the same category into the second prompt template, generate the fifth intermediate prompt and input the fifth intermediate prompt into the second model corresponding to the same category, and obtain the answer output by the second model corresponding to the same category. There are a plurality of second models, and each second model corresponds to a different category.

Preferably, the obtaining module includes a second receiving module, an eighteenth construction interaction module, a nineteenth construction interaction module, a third user interaction module, and a twentieth construction interaction module.

The second receiving module receives answer information output by the first model.

In a case where the answer information output by the first model includes at least one third question which cannot be answered by the first model, the eighteenth construction interaction module determines whether the at least one third question is a first question or a second question. The first question is a question which can be answered by the second model, and the second question is a question which cannot be answered by the second model.

For the first question, the nineteenth construction interaction module generates a sixth intermediate prompt according to the original prompt, the first question and a preset second prompt template, and inputs the sixth intermediate prompt into the second model to obtain an answer output by the second model. The second prompt template is used to prompt the original prompt to the second model, and to request the second model to answer the first question.

For the second question, the third user interaction module prompts the second question to a user, and receives an answer input by the user.

A twentieth construction interaction module generates a tenth optimized prompt according to the original prompt, a fifth answer and a seventh prompt template, and inputs the tenth optimized prompt into the first model. The seventh prompt template is used to prompt the original prompt and the fifth answer to the first model, and to request the first model to answer the original prompt again. The fifth answer includes at least one of the answer input by the user, the answer output by the second model, and the answer of the first model to at least one fourth question. The fourth question is a question which can be answered by the first model.

Preferably, the nineteenth construction interaction module generates the sixth intermediate prompt and inputs the sixth intermediate prompt into the second model to obtain the answer output by the second model by any one of the following methods.

Method 1: fill the original prompt and the first question into the second prompt template, generate the sixth intermediate prompt and input the sixth intermediate prompt into the same second model, and obtain the answer output by the second model.

Method 2: determine the category to which each question among the first questions belongs, fill the original prompt and the questions belonging to the same category into the second prompt template, generate the sixth intermediate prompt and input the sixth intermediate prompt into the second model corresponding to the same category, and obtain the answer output by the second model corresponding to the same category. There are a plurality of second models, and each second model corresponds to a different category.

Preferably, the obtaining module further includes a display module.

In a case where the answer information includes the answer of the first model to the original prompt, the display module displays the answer of the first model to the original prompt.

Note that the various devices provided in the above embodiments are apparatuses corresponding to the above tuning prompt method, and the implementation methods in the above embodiments are all applicable to the embodiments of the apparatuses, and can also achieve the same technical effect. The above-mentioned apparatus provided in the embodiment of the present disclosure may implement all the in the above-mentioned method steps implemented method embodiments, and can achieve the same technical effect. The parts and beneficial effects that are the same as those in the method embodiment in this embodiment will not be described in detail here.

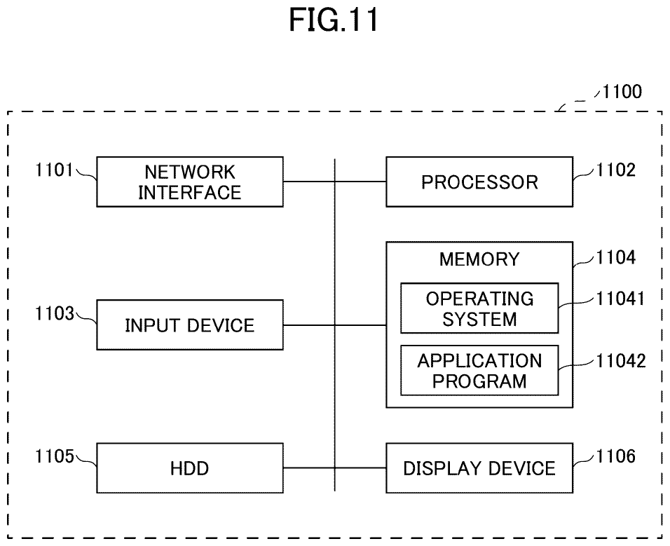

FIG. 11 is a block diagram illustrating an example of a configuration of prompt tuning apparatus according to another embodiment of the present disclosure. As shown in FIG. 11, the prompt tuning apparatus 1100 includes a processor 1102, and a memory 1104 storing computer-executable instructions.

When the computer-executable instructions are executed by the processor 1102, the processor 1102 are configured to perform the following steps.

An original prompt input by a user is received.

A first model is guided to start a question answering process based on the original prompt, and is requested the first model to answer the original prompt according to the original prompt and context information obtained in the question answering process. The question answering process includes at least one of a process where the first model asks a question and the second model answers the question, and a process where the first model asks a question and answers the question.

The answer to the original prompt generated by the first model is obtained.

Note that the various systems provided in the above embodiments are apparatuses corresponding to the above the prompt tuning methods, and implementation methods in the above embodiments are applicable to the embodiments of the device, and can also achieve the same technical effect. The above apparatus provided in the embodiment of the present disclosure may implement all the method steps implemented in the above method embodiment, and can achieve the same technical effect. The parts and beneficial effects that are the same as the method embodiment in this embodiment will not be described in detail here.

Furthermore, as shown in FIG. 11, the prompt tuning apparatus 1100 further includes a network interface 1101, an input device 1103, a hard disk drive (HDD) 1105, and a display device 1106.

Each of the ports and each of the devices may be connected to each other via a bus architecture. The processor 1102, such as one or more central processing units (CPUs), and the memory 1104, such as one or more memory units, may be connected via various circuits. Other circuits such as an external device, a regulator, and a power management circuit may also be connected via the bus architecture. Note that these devices are communicably connected via the bus architecture. The bus architecture includes a power supply bus, a control bus and a status signal bus besides a data bus. The detailed description of the bus architecture is omitted here.

The network interface 1101 may be connected to a network (such as the Internet, a LAN or the like).

The input device 1103 may receive various commands such as predetermined threshold and its setting information input by a user, and transmit the commands to the processor 1102 to be executed. The input device 1103 may include a keyboard, pointing devices (such as a mouse or a track ball), a touch board, a touch panel or the like.

The display device 1106 may display a result obtained by the processor 1102 executing instructions, such as display a model training progress and the like.

The memory 1104 stores programs and data required for running an operating system, and data such as intermediate results in calculation processes of the processor 1102.

Note that the memory 1104 of the embodiments of present disclosure may be a volatile memory or a nonvolatile memory, or may include both a volatile memory and a nonvolatile memory. The nonvolatile memory may be a read-only memory (ROM), a programmable read-only memory (PROM), an erasable programmable read-only memory (EPROM), an electrically erasable programmable read-only memory (EEPROM) or a flash memory. The volatile memory may be a random access memory (RAM), which may be used as an external high-speed buffer. The memory 1104 of the apparatus or the method is not limited to the described types of memory, and may include any other suitable memory.

In some embodiments, the memory 1104 stores executable modules or data structure, their subsets, or their superset, i.e., an operating system (OS) 11041 and an application program 11042.

The operating system 11041 includes various system programs for implementing various essential tasks and processing tasks based on hardware, such as a frame layer, a core library layer, a drive layer and the like. The application program 11042 includes various application programs for implementing various application tasks, such as a browser and the like. A program for implementing the method according to the embodiments of the present disclosure may be included in the application program 11042.

The method according to the above embodiments of the present disclosure may be applied to the processor 1102 or may be implemented by the processor 1102. The processor 1102 may be an integrated circuit chip capable of processing signals. Each step of the above method may be implemented by instructions in a form of integrated logic circuit of hardware in the processor 1102 or a form of software. The processor 1102 may be a general-purpose processor, a digital signal processor (DSP), an application specific integrated circuit (ASIC), field programmable gate array signals (FPGA) or other programmable logic device (PLD), a discrete gate or transistor logic, discrete hardware components capable of implementing or executing the methods, the steps and the logic blocks of the embodiments of the present disclosure. The general-purpose processor may be a micro-processor, or alternatively, the processor may be any common processor. The steps of the method according to the embodiments of the present disclosure may be implemented by a hardware decoding processor, or combination of hardware modules and software modules in a decoding processor. The software modules may be located in a conventional storage medium such as a random access memory (RAM), a flash memory, a read-only memory (ROM), an erasable programmable read-only memory (EPROM), an electrically erasable programmable read-only memory (EEPROM), a register or the like. The storage medium is located in the memory 1104, and the processor 1102 reads information in the memory 1104 and implements the steps of the above methods in combination with hardware.

Note that the embodiments described herein may be implemented by hardware, software, firmware, or any combination intermediate code, microcode thereof. For hardware implementation, the processor may be implemented in one or more application specific integrated circuits (ASIC), digital signal processors (DSP), digital signal processing devices (DSPD), programmable logic devices (PLD), field programmable gate array signals (FPGA), general-purpose processors, controllers, micro-controllers, micro-processors, or other electronic components or their combinations for implementing functions of the present disclosure.

For software implementation, the embodiments of the present disclosure may be implemented by executing functional modules (such as processes, functions or the like). Software codes may be stored in a memory and executed by a processor. The memory may be implemented inside or outside the processor.

Preferably, when the computer-readable instructions are executed by the processor 1102, the processor 1102 is configured to generate an optimized prompt according to the original prompt and a preset prompt template, and input the optimized prompt into the first model. The prompt template is used to guide the first model to start the question answering process according to the original prompt, and to request the first model to answer the original prompt according to the original prompt and the context information obtained in the question answering process.

Preferably, when the computer-readable instructions are executed by the processor 1102, the processor 1102 is configured to generate a first optimized prompt according to the original prompt and the preset first prompt template, and input the first optimized prompt into the first model to obtain at least one question output by the first model. The first prompt template is used to prompt the original prompt, and to request the first model to ask a question according to the original prompt.

The processor 1102 is further configured to generate a first intermediate prompt according to the original prompt, the at least one question and a preset second prompt template, and input first intermediate prompt into the second model to obtain an answer output by the second model. The second prompt template is used to prompt the original prompt to the second model, and to request the second model to answer the question.

The processor 1102 is further configured to generate a second optimized prompt according to the original prompt, the answer output by the second model and a third prompt template, and input second optimized prompt into the first model. The third prompt template is used to prompt the original prompt and the answer output by the second model to the first model, and to request the first model to answer the original prompt.

Preferably, when the computer-readable instructions are executed by the processor 1102, the processor 1102 is configured to generate the first intermediate prompt and input the first intermediate prompt into the second model to obtain the answer output by the second model by any one of the following methods.

Method 1: fill the original prompt and the questions output by the first model into the second prompt template, generate the first intermediate prompt and input the first intermediate prompt into the same second model, and obtain the answers output by the second model.

Method 2: determine a category to which each question output by the first model belongs, fill the original prompt and the questions belonging to the same category into the second prompt template, generate the first intermediate prompt and input the first intermediate prompt into the second model corresponding to the same category, and obtain the answer output by the second model corresponding to the same category. There are a plurality of second models, each of which corresponds to a different category. The question category corresponding to a second model may be one or more.

Preferably, when the computer-readable instructions are executed by the processor 1102, the processor 1102 is configured to generate a first optimized prompt according to the original prompt and a preset first prompt template, and input the first optimized prompt into the first model to obtain at least one question output by the first model. The first prompt template is used to prompt the original prompt, and to request the first model to ask a question according to the original prompt.

The processor 1102 is further configured to determine whether the at least one question is a first question or a second question. The first question is a question which can be answered by the second model, and the second question is a question which cannot be answered by the second model.

The processor 1102 is further configured to, for the first question, generate a second intermediate prompt according to the original prompt, the first question and a preset second prompt template, and input the second intermediate prompt into the second model to obtain an answer output by the second model. The second prompt template is used to prompt the original prompt to the second model, and to request the second model to answer the first question.

The processor 1102 is further configured to, for the second question, prompt the second question to a user, and receive an answer input by the user.

The processor 1102 is further configured to generate a third optimized prompt according to the original prompt, a first answer and a third prompt template, and input the third optimized prompt into the first model. The third prompt template is used to prompt the original prompt and the first answer to the first model, and to request the first model to answer the original prompt. The first answer includes at least one of the answer output by the second model, and the answer input by the user.

Preferably, when the computer-readable instructions are executed by the processor 1102, the processor 1102 is configured to generate the second intermediate prompt and input the second intermediate prompt into the second model to obtain the answer output by the second model by any one of the following methods.

Method 1: fill the original prompt and the first question into the second prompt template, generate the second intermediate prompt and input the second intermediate prompt into the same second model, and obtain the answer output by the second model.

Method 2: determine the category to which each question among the first questions belongs, fill the original prompt and the question belonging to the same category into the second prompt template, generate the second intermediate prompt and input the second intermediate prompt into the second model corresponding to the same category, and obtain the answer output by the second model corresponding to the same category. There are a plurality of second models, each of which corresponds to a different category.

Preferably, when the computer-readable instructions are executed by the processor 1102, the processor 1102 is configured to generate a fourth optimized prompt according to the original prompt and the preset fourth prompt template, and input the fourth optimized prompt into the first model to obtain an answer output by the first model. The fourth prompt template is used to prompt the original prompt, and to request the first model to ask a question and output the answer according to the original prompt.

The processor 1102 is further configured to generate a fifth optimized prompt according to the original prompt and the fifth prompt template, and input the fifth optimized prompt into the first model. The fifth prompt template is used to prompt the original prompt to the first model, and to request the first model to answer the original prompt.

Preferably, when the computer-readable instructions are executed by the processor 1102, the processor 1102 is configured to generate a fourth optimized prompt according to the original prompt and a preset fourth prompt template, and input the fourth optimized prompt into the first model to obtain an answer output by the first model. The fourth prompt template is used to prompt the original prompt, and to request the first model to ask a question and output the answer according to the original prompt.

In a case where the answer output by the first model includes at least one third question which cannot be answered by the first model, the processor 1102 is further configured to generate a third intermediate prompt according to the original prompt, the at least one third question and a preset second prompt template, and input the third intermediate prompt into the second model to obtain an answer output by the second model. The second prompt template is used to prompt the original prompt to the second model, and to request the second model to answer the third question.

The processor 1102 is further configured to generate a sixth optimized prompt according to the original prompt, a second answer and a third prompt template, and input the sixth optimized prompt into the first model. The third prompt template is used to prompt the original prompt and the second answer to the first model, and to request the first model to answer the original prompt. The second answer includes at least one of the answer output by the second model, and the answer of the first model to at least one fourth question. The fourth question is a question which can be answered by the first model.

Preferably, when the computer-readable instructions are executed by the processor 1102, the processor 1102 is configured to generate the third intermediate prompt and input the third intermediate prompt into the second model to obtain the answer output by the second model by any one of the following methods.

Method 1: fill the original prompt and each third question into the second prompt template, generate the third intermediate prompt and input the third intermediate prompt into the same second model, and obtain the answer output by the second model.

Method 2: determine the category to which each third question belongs, fill the original prompt and the third question belonging to the same category into the second prompt template, generate the third intermediate prompt and input the third intermediate prompt into the second model corresponding to the same category, and obtain the answer output by the second model corresponding to the same category. There are a plurality of second models, and each second model corresponds to a different category.

Preferably, when the computer-readable instructions are executed by the processor 1102, the processor 1102 is configured to generate a fourth optimized prompt according to the original prompt and a preset fourth prompt template, and input the fourth optimized prompt into the first model to obtain an answer output by the first model. The fourth prompt template is used to prompt the original prompt, and to request the first model to ask a question and output the answer according to the original prompt.

In a case where the answer output by the first model includes at least one third question which is asked by the first model and cannot be answered by the first model, the processor 1102 is further configured to determine whether the at least one third question is a first question or a second question. The first question is a question which can be answered by the second model, and the second question is a question which cannot be answered by the second model.

For the first question, the processor 1102 is further configured to generate a fourth intermediate prompt according to the original prompt, the first question and a preset second prompt template, and input the fourth intermediate prompt into the second model to obtain an answer output by the second model. The second prompt template is used to prompt the original prompt to the second model, and to request the second model to answer the first question.

For the second question, the processor 1102 is further configured to prompt the second question to a user, and receive an answer input by the user.

The processor 1102 is further configured to generate a seventh optimized prompt according to the original prompt, a third answer and a third prompt template, and input the seventh optimized prompt into the first model. The third prompt template is used to prompt the original prompt and the third answer to the first model, and to request the first model to answer the original prompt. The third answer includes at least one of the answer input by the user, the answer output by the second model, and the answer of the first model to at least one fourth question. The fourth question is a question which is asked by the first model and can be answered by the first model.

Preferably, when the computer-readable instructions are executed by the processor 1102, the processor 1102 is configured to generate the fourth intermediate prompt and input the fourth intermediate prompt into the second model to obtain the answer output by the second model by any one of the following methods.

Method 1: fill the original prompt and the third question into the second prompt template, generate the fourth intermediate prompt and input the fourth intermediate prompt into the same second model, and obtain the answer output by the second model.

Method 2: determine the category to which each third question belongs, fill the original prompt and the third questions belonging to the same category into the second prompt template, generate the fourth intermediate prompt and input the fourth intermediate prompt into the second model corresponding to the same category, and obtain the answer output by the second model corresponding to the same category. There are a plurality of second models, and each second model corresponds to a different category.

Preferably, when the computer-readable instructions are executed by the processor 1102, the processor 1102 is configured to receive and display the answer to the original prompt output by the first model.

Preferably, when the computer-readable instructions are executed by the processor 1102, the processor 1102 is configured to generate an eighth optimized prompt according to the original prompt and a sixth prompt template, and input the eighth optimized prompt into the first model. The sixth prompt template is used to prompt the original prompt, and to request the first model to ask a question and answer the question according to the original prompt, and answer the original prompt.

Preferably, when the computer-readable instructions are executed by the processor 1102, the processor 1102 is configured to receive answer information output by the first model.

In a case where the answer information output includes at least one third question which cannot be answered by the first model, the processor 1102 is further configured to generate a fifth intermediate prompt according to the original prompt, the at least one third question and a preset second prompt template, and input the fifth intermediate prompt into the second model to obtaining an answer output by the second model. The second prompt template is used to prompt the original prompt to the second model, and to request the second model to answer the third question.

The processor 1102 is further configured to generate a ninth optimized prompt according to the original prompt, a fourth answer and a seventh prompt template, and input the ninth optimized prompt into the first model. The seventh prompt template is used to prompt the original prompt and the fourth answer to the first model, and to request the first model to answer the original prompt again. The fourth answer includes at least one of the answer output by the second model, and the answer of the first model to at least one fourth question. The fourth question is a question which is asked by the first model and can be answered by the first model.

Preferably, when the computer-readable instructions are executed by the processor 1102, the processor 1102 is configured to generate the fifth intermediate prompt and input the fifth intermediate prompt into the second model to obtain the answer output by the second model by any one of the following methods.

Method 1: fill the original prompt and each third question into the second prompt template, generate the fifth intermediate prompt and input the fifth intermediate prompt into the same second model, and obtain the answer output by the second model.

Method 2: determine the category to which each third question belongs, fill the original prompt and the third question belonging to the same category into the second prompt template, generate the fifth intermediate prompt and input the fifth intermediate prompt into the second model corresponding to the same category, and obtain the answer output by the second model corresponding to the same category. There are a plurality of second models, and each second model corresponds to a different category.

Preferably, when the computer-readable instructions are executed by the processor 1102, the processor 1102 is configured to receive answer information output by the first model.

In a case where the answer information output by the first model includes at least one third question which cannot be answered by the first model, the processor 1102 is further configured to determine whether the at least one third question is a first question or a second question. The first question is a question which can be answered by the second model, and the second question is a question which cannot be answered by the second model.

The processor 1102 is further configured to, for the first question, generate a sixth intermediate prompt according to the original prompt, the first question and a preset second prompt template, and input the sixth intermediate prompt into the second model to obtain an answer output by the second model. The second prompt template is used to prompt the original prompt to the second model, and to request the second model to answer the first question.

The processor 1102 is further configured to, for the second question, prompt the second question to a user, and receive an answer input by the user.

The processor 1102 is further configured to generate a tenth optimized prompt according to the original prompt, a fifth answer and a seventh prompt template, and input the tenth optimized prompt into the first model. The seventh prompt template is used to prompt the original prompt and the fifth answer to the first model, and to request the first model to answer the original prompt again. The fifth answer includes at least one of the answer input by the user, the answer output by the second model, and the answer of the first model to at least one fourth question. The fourth question is a question which can be answered by the first model.

Preferably, when the computer-readable instructions are executed by the processor 1102, the processor 1102 is configured to generate the sixth intermediate prompt and input the sixth intermediate prompt into the second model to obtain the answer output by the second model by any one of the following methods.

Method 1: fill the original prompt and the first question into the second prompt template, generate the sixth intermediate prompt and input the sixth intermediate prompt into the same second model, and obtain the answer output by the second model.

Method 2: determine the category to which each question among the first questions belongs, fill the original prompt and the questions belonging to the same category into the second prompt template, generate the sixth intermediate prompt and input the sixth intermediate prompt into the second model corresponding to the same category, and obtain the answer output by the second model corresponding to the same category. There are a plurality of second models, and each second model corresponds to a different category.

Preferably, in a case where the answer information includes the answer of the first model to the original prompt, when the computer-readable instructions are executed by the processor 1102, the processor 1102 is configured to display the answer of the first model to the original prompt.

When the program is executed by the processor, all implementation methods in the above prompt tuning method can be implemented, and the same technical effect can be achieved. To avoid repetition, it will not be repeated here.

In another embodiment of the present disclosure, a non-transitory computer-readable recording medium having computer-executable instructions for execution by one or more processors is further provided. The execution of the computer-executable instructions cause the one or more processors to carry out a prompt tuning method. The prompt tuning method includes receiving an original prompt input by a user; guiding a first model to start a question answering process based on the original prompt, and requesting the first model to answer the original prompt according to the original prompt and context information obtained in the question answering process, the question answering process including at least one of a process where the first model asks a question and the second model answers the question, and a process where the first model asks a question and answers the question; and obtaining the answer to the original prompt generated by the first model.

As known by a person skilled in the art, the elements and algorithm steps of the embodiments disclosed herein may be implemented by electronic hardware or a combination of computer software and electronic hardware. Whether these functions are performed by hardware or software depends on the specific application and design constraints of the solution. A person skilled in the art may use different methods for implementing the described functions for each particular application, but such implementation should not be considered to be beyond the scope of the present disclosure.

As clearly understood by a person skilled in the art, for the convenience and brevity of the the specific working process of the description, system, the device and the unit described above may refer to the corresponding process in the above method embodiment, and detailed descriptions thereof are omitted here.

In the embodiments of the present disclosure, it should be understood that the disclosed apparatus and method may be implemented in other manners. For example, the device embodiments described above are merely illustrative. For example, the division of the unit is only a logical function division. In actual implementation, there may be another division manner, for example, units or components may be combined or be integrated into another system, or some features may be ignored or not executed. In addition, the coupling or direct coupling or communication connection described above may be an indirect coupling or communication connection through some interface, device or unit, and may be electrical, mechanical or the like.

The units described as separate components may be or may not be physically separated, and the components displayed as units may be or may not be physical units, that is to say, the units may be located in one place, or may be distributed across network units. Some or all of the units may be selected according to actual needs to achieve the objectives of the embodiments of the present disclosure.

In addition, each functional unit the embodiments of the present disclosure may be integrated into one processing unit, or each unit may exist physically separately, or two or more units may be integrated into one unit.

The functions may be stored in a computer readable storage medium if the functions are implemented in the form of a software functional unit and sold or used as an independent product. Based on such understanding, the technical solution of the present disclosure, which is essential or contributes to the prior art, or a part of the technical solution, may be embodied in the form of a software product, which is stored in a storage medium, including instructions that are used to cause a computer device (which may be a personal computer, a server, or a network device, etc.) to perform all or a part of the steps of the methods described in the embodiments of the present disclosure. The above storage medium includes various media that can store program codes, such as a USB flash drive, a mobile hard disk, a ROM, a RAM, a magnetic disk, or an optical disk.

The present disclosure is not limited to the specifically described embodiments, and various modifications, combinations and replacements may be made without departing from the scope of the present disclosure.

What is claimed is:

1. A prompt tuning method, comprising:
receiving an original prompt input by a user;
guiding a first model to start a question answering process based on the original prompt, and requesting the first model to answer the original prompt according to the original prompt and context information obtained in the question answering process, the question answering process including at least one of a process where the first model asks a question and the second model answers the question, and a process where the first model asks a question and answers the question; and
obtaining the answer to the original prompt generated by the first model.

2. The prompt tuning method as claimed in claim 1,
wherein the guiding the first model to start the question answering process and requesting the first model to answer the original prompt includes
generating an optimized prompt according to the original prompt and a preset prompt template, and inputting the optimized prompt into the first model, the prompt template being used to guide the first model to start the question answering process according to the original prompt, and to request the first model to answer the original prompt according to the original prompt and the context information obtained in the question answering process.

3. The prompt tuning method as claimed in claim 2,
wherein the generating the optimized prompt and inputting the optimized prompt into the first model includes
generating a first optimized prompt according to the original prompt and a preset first prompt template, and inputting the first optimized prompt into the first model to obtain at least one question output by the first model, the first prompt template being used to prompt the original prompt, and to request the first model to ask a question according to the original prompt;
generating a first intermediate prompt according to the original prompt, the at least one question and a preset second prompt template, and inputting first intermediate prompt into the second model to obtain an answer output by the second model, the second prompt template being used to prompt the original prompt to the second model, and to request the second model to answer the question; and
generating a second optimized prompt according to the original prompt, the answer output by the second model and a third prompt template, and inputting second optimized prompt into the first model, the third prompt template being used to prompt the original prompt and the answer output by the second model to the first model, and to request the first model to answer the original prompt.

4. The prompt tuning method as claimed in claim 2,
wherein the generating the optimized prompt and inputting the optimized prompt into the first model includes
generating a first optimized prompt according to the original prompt and a preset first prompt template, and inputting the first optimized prompt into the first model to obtain at least one question output by the first model, the first prompt template being used to prompt the original prompt, and to request the first model to ask a question according to the original prompt;
determining whether the at least one question is a first question or a second question, the first question being a question which can be answered by the second model, and the second question being a question which cannot be answered by the second model;
for the first question, generating a second intermediate prompt according to the original prompt, the first question and a preset second prompt template, and inputting the second intermediate prompt into the second model to obtain an answer output by the second model, the second prompt template being used to prompt the original prompt to the second model, and to request the second model to answer the first question;
for the second question, prompting the second question to a user, and receiving an answer input by the user; and
generating a third optimized prompt according to the original prompt, a first answer and a third prompt template, and inputting the third optimized prompt into the first model, the third prompt template being used to prompt original prompt and the first answer to the first model, and to request the first model to answer the original prompt, and the first answer including at least one of the answer output by the second model, and the answer input by the user.

5. The prompt tuning method as claimed in claim 2,
wherein the generating the optimized prompt and inputting the optimized prompt into the first model includes
generating a fourth optimized prompt according to the original prompt and a preset fourth prompt template, and inputting the fourth optimized prompt into the first model to obtain an answer output by the first model, the fourth prompt template being used to prompt the original prompt, and to request the first model to ask a question and output the answer according to the original prompt; and
generating a fifth optimized prompt according to the original prompt and a fifth prompt template, and inputting the fifth optimized prompt into the first model, the fifth prompt template being used to prompt the original prompt to the first model, and to request the first model to answer the original prompt.

6. The prompt tuning method as claimed in claim 2,
wherein the generating the optimized prompt and inputting the optimized prompt into the first model includes
generating a fourth optimized prompt according to the original prompt and a preset fourth prompt template, and inputting the fourth optimized prompt into the first model to obtain an answer output by the first model, the fourth prompt template being used to prompt the original prompt, and to request the first model to ask a question and output the answer according to the original prompt;
in a case where the answer output by the first model includes at least one third question which cannot be answered by the first model, generating a third intermediate prompt according to the original prompt, the at least one third question and a preset second prompt template, and inputting the third intermediate prompt into the second model to obtain an answer output by the second model, the second prompt template being used to prompt the original prompt to the second model, and to request the second model to answer the third question; and
generating a sixth optimized prompt according to the original prompt, a second answer and a third prompt template, and inputting the sixth optimized prompt into the first model, the third prompt template being used to prompt the original prompt and the second answer to the first model, and to request the first model to answer the original prompt, the second answer including at least one of the answer output by the second model, and the answer of the first model to at least one fourth question, and the fourth question being a question which can be answered by the first model.

7. The prompt tuning method as claimed in claim 2,
wherein the generating the optimized prompt and inputting the optimized prompt into the first model includes
generating a fourth optimized prompt according to the original prompt and a preset fourth prompt template, and inputting the fourth optimized prompt into the first model to obtain an answer output by the first model, the fourth prompt template being used to prompt the original prompt, and to request the first model to ask a question and output the answer according to the original prompt;
in a case where the answer output by the first model includes at least one third question which is asked by the first model and cannot be answered by the first model, determining whether the at least one third question is a first question or a second question, the first question being a question which can be answered by the second model, and the second question being a question which cannot be answered by the second model;
for the first question, generating a fourth intermediate prompt according to the original prompt, the first question and a preset second prompt template, and inputting the fourth intermediate prompt into the second model to obtain an answer output by the second model, the second prompt template being used to prompt the original prompt to the second model, and to request the second model to answer the first question;
for the second question, prompting the second question to a user, and receiving an answer input by the user; and
generating a seventh optimized prompt according to the original prompt, a third answer and a third prompt template, and inputting the seventh optimized prompt into the first model, the third prompt template being used to prompt the original prompt and the third answer to the first model, and to request the first model to answer the original prompt, the third answer including at least one of the answer input by the user, the answer output by the second model, and the answer of the first model to at least one fourth question, and the fourth question being a question which is asked by the first model and can be answered by the first model.

8. The prompt tuning method as claimed in claim 3,
wherein obtaining the answer to the original prompt generated by the first model includes
receiving the answer to the original prompt output by the first model and displaying the answer.

9. The prompt tuning method as claimed in claim 2,
wherein the generating the optimized prompt and inputting the optimized prompt into the first model includes
generating an eighth optimized prompt according to the original prompt and a sixth prompt template, and inputting the eighth optimized prompt into the first model, the sixth prompt template being used to prompt the original prompt, and to request the first model to ask a question and answer the question according to the original prompt, and answer the original prompt.

10. The prompt tuning method as claimed in claim 9,
wherein obtaining the answer to the original prompt generated by the first model includes
receiving answer information output by the first model;
in a case where the answer information output includes at least one third question which cannot be answered by the first model, generating a fifth intermediate prompt according to the original prompt, the at least one third question and a preset second prompt template, and inputting the fifth intermediate prompt into the second model to obtaining an answer output by the second model, the second prompt template being used to prompt the original prompt to the second model, and to request the second model to answer the third question; and
generating a ninth optimized prompt according to the original prompt, a fourth answer and a seventh prompt template, and inputting the ninth optimized prompt into the first model, the seventh prompt template being used to prompt the original prompt and the fourth answer to the first model, and to request the first model to answer the original prompt again, the fourth answer including at least one of the answer output by the second model, and the answer of the first model to at least one fourth question, the fourth question being a question which is asked by the first model and can be answered by the first model.

11. The prompt tuning method as claimed in claim 9,
wherein obtaining the answer to the original prompt generated by the first model includes
receiving answer information output by the first model;
in a case where the answer information output by the first model includes at least one third question which cannot be answered by the first model, determining whether the at least one third question is a first question or a second question, the first question being a question which can be answered by the second model, and the second question being a question which cannot be answered by the second model;
for the first question, generating a sixth intermediate prompt according to the original prompt, the first question and a preset second prompt template, and inputting the sixth intermediate prompt into the second model to obtain an answer output by the second model, the second prompt template being used to prompt the original prompt to the second model, and to request the second model to answer the first question;
for the second question, prompting the second question to a user, and receiving an answer input by the user; and
generating a tenth optimized prompt according to the original prompt, a fifth answer and a seventh prompt template, and inputting the tenth optimized prompt into the first model, the seventh prompt template being used to prompt the original prompt and the fifth answer to the first model, and to request the first model to answer the original prompt again, the fifth answer including at least one of the answer input by the user, the answer output by the second model, and the answer of the first model to at least one fourth question, and the fourth question being a question which can be answered by the first model.

12. The prompt tuning method as claimed in claim 10,
wherein obtaining the answer to the original prompt generated by the first model includes
in a case where the answer information includes the answer of the first model to the original prompt, displaying the answer of the first model to the original prompt.

13. An prompt tuning apparatus, comprising:
a memory storing computer-executable instructions; and
one or more processors configured to execute the computer-executable instructions such that the one or more processors are configured to
receive an original prompt input by a user;
guide a first model to start a question answering process based on the original prompt, and request the first model to answer the original prompt according to the original prompt and context information obtained in the question answering process, the question answering process including at least one of a process where the first model asks a question and the second model answers the question, and a process where the first model asks a question and answers the question; and
obtain the answer to the original prompt generated by the first model.

14. The prompt tuning apparatus as claimed in claim 13,
wherein the one or more processors are configured to
generate an optimized prompt according to the original prompt and a preset prompt template, and input the optimized prompt into the first model, the prompt template being used to guide the first model to start the question answering process according to the original prompt, and to request the first model to answer the original prompt according to the original prompt and the context information obtained in the question answering process.

15. The prompt tuning apparatus as claimed in claim 14,
wherein the one or more processors are configured to
generate a first optimized prompt according to the original prompt and a preset first prompt template, and input the first optimized prompt into the first model to obtain at least one question output by the first model, the first prompt template being used to prompt the original prompt, and to request the first model to ask a question according to the original prompt;
generate a first intermediate prompt according to the original prompt, the at least one question and a preset second prompt template, and input first intermediate prompt into the second model to obtain an answer output by the second model, the second prompt template being used to prompt the original prompt to the second model, and to request the second model to answer the question; and
generate a second optimized prompt according to the original prompt, the answer output by the second model and a third prompt template, and input second optimized prompt into the first model, the third prompt template being used to prompt the original prompt and the answer output by the second model to the first model, and to request the first model to answer the original prompt.

16. The prompt tuning apparatus as claimed in claim 14,
wherein the one or more processors are configured to
generate a first optimized prompt according to the original prompt and a preset first prompt template, and input the first optimized prompt into the first model to obtain at least one question output by the first model, the first prompt template being used to prompt the original prompt, and to request the first model to ask a question according to the original prompt;
determine whether the at least one question is a first question or a second question, the first question being a question which can be answered by the second model, and the second question being a question which cannot be answered by the second model;
for the first question, generate a second intermediate prompt according to the original prompt, the first question and a preset second prompt template, and input the second intermediate prompt into the second model to obtain an answer output by the second model, the second prompt template being used to prompt the original prompt to the second model, and to request the second model to answer the first question;
for the second question, prompt the second question to a user, and receive an answer input by the user; and
generate a third optimized prompt according to the original prompt, a first answer and a third prompt template, and input the third optimized prompt into the first model, the third prompt template being used to prompt the original prompt and the first answer to the first model, and to request the first model to answer the original prompt, and the first answer including at least one of the answer output by the second model, and the answer input by the user.

17. The prompt tuning apparatus as claimed in claim 14,
wherein the one or more processors are configured to
generate a fourth optimized prompt according to the original prompt and a preset fourth prompt template, and input the fourth optimized prompt into the first model to obtain an answer output by the first model, the fourth prompt template being used to prompt the original prompt, and to request the first model to ask a question and output the answer according to the original prompt; and
generate a fifth optimized prompt according to the original prompt and a fifth prompt template, and input the fifth optimized prompt into the first model, the fifth prompt template being used to prompt the original prompt to the first model, and to request the first model to answer the original prompt.

18. The prompt tuning apparatus as claimed in claim 14,
wherein the one or more processors are configured to
generate a fourth optimized prompt according to the original prompt and a preset fourth prompt template, and input the fourth optimized prompt into the first model to obtain an answer output by the first model, the fourth prompt template being used to prompt the original prompt, and to request the first model to ask a question and output the answer according to the original prompt;
in a case where the answer output by the first model includes at least one third question which cannot be answered by the first model, generate a third intermediate prompt according to the original prompt, the at least one third question and a preset second prompt template, and input the third intermediate prompt into the second model to obtain an answer output by the second model, the second prompt template being used to prompt the original prompt to the second model, and to request the second model to answer the third question; and
generate a sixth optimized prompt according to the original prompt, a second answer and a third prompt template, and input the sixth optimized prompt into the first model, the third prompt template being used to prompt the original prompt and the second answer to the first model, and to request the first model to answer the original prompt, the second answer including at least one of the answer output by the second model, and the answer of the first model to at least one fourth question, and the fourth question being a question which can be answered by the first model.

19. The prompt tuning apparatus as claimed in claim 14,
wherein the one or more processors are configured to
generate a fourth optimized prompt according to the original prompt and a preset fourth prompt template, and input the fourth optimized prompt into the first model to obtain an answer output by the first model, the fourth prompt template being used to prompt the original prompt, and to request the first model to ask a question and output the answer according to the original prompt;
in a case where the answer output by the first model includes at least one third question which is asked by the first model and cannot be answered by the first model, determine whether the at least one third question is a first question or a second question, the first question being a question which can be answered by the second model, and the second question being a question which cannot be answered by the second model;
for the first question, generate a fourth intermediate prompt according to the original prompt, the first question and a preset second prompt template, and input the fourth intermediate prompt into the second model to obtain an answer output by the second model, the second prompt template being used to prompt the original prompt to the second model, and to request the second model to answer the first question;
for the second question, prompt the second question to a user, and receive an answer input by the user; and
generate a seventh optimized prompt according to the original prompt, a third answer and a third prompt template, and input the seventh optimized prompt into the first model, the third prompt template being used to prompt the original prompt and the third answer to the first model, and to request the first model to answer the original prompt, the third answer including at least one of the answer input by the user, the answer output by the second model, and the answer of the first model to at least one fourth question, and the fourth question being a question which is asked by the first model and can be answered by the first model.

20. A non-transitory computer-readable recording medium having computer-executable instructions for execution by one or more processors, wherein, the computer-executable instructions, when executed, cause the one or more processors to carry out a prompt tuning method, the prompt tuning method comprising:
receiving an original prompt input by a user;
guiding a first model to start a question answering process based on the original prompt, and requesting the first model to answer the original prompt according to the original prompt and context information obtained in the question answering process, the question answering process including at least one of a process where the first model asks a question and the second model answers the question, and a process where the first model asks a question and answers the question; and
obtaining the answer to the original prompt generated by the first model.
